(19) United States
(12) Patent Application Publication
(10) Pub. No.: US 2005/0238878 A1
(43) Pub. Date: Oct. 27, 2005

(54) Device mounting board

(76) Inventors: Ryosuke Usui, Ichinomiya-City (JP); Takeshi Nakamura, Sawa-Gun (JP); Noriaki Kojima, Ogaki-City (JP); Hiroyuki Watanabe, Bisai-City (JP)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 11/086,640

(22) Filed: Mar. 22, 2005

(30) Foreign Application Priority Data
Mar. 31, 2004 (JP) 2004-105764
Mar. 31, 2004 (JP) 2004-106228
Mar. 31, 2004 (JP) 2004-105583

(51) Int. Cl. B32B 27/00; B32B 15/04

(52) U.S. Cl. 428/411.1; 428/901; 428/457

(57) ABSTRACT

A miniaturized device mounting board having high reliability is provided. A material constituting a photoimageable solder resist layer 328 can be formed into a thin film while voids and unevenness are suppressed to occur by using a cardo type polymer which is of a base material and a predetermined additive. Therefore, a film having a thickness of about 25 μm can be used as the material constituting the photoimageable solder resist layer 328. The material constituting photoimageable solder resist layer 328 becomes about two-thirds in thickness, when compared with the conventional resin material having the thickness of about 35 μm, which is used as the photoimageable solder resist layer 328. Accordingly, a device mounting board 400 can be miniaturized.

### BACKGROUND OF THE INVENTION

1. Field of the Invention

The present invention relates to a device mounting board and a semiconductor apparatus using the device mounting board.

2. Description of the Related Art

Recently, multifunction and high performance of portable electronic devices such as a cellular phone, PDA, DVC, and DSC are accelerated, so that miniaturization and weight reduction are necessary in order that such electronic devices are accepted in the market. A highly integrated system-LSI is required in order to realize the miniaturization and the weight reduction. On the other hand, the ease-to-use and convenient electronic devices are demanded, and the multifunction and the high performance are also demanded for LSIs used in the electronic devices. Therefore, while the number of I/Os are increased as an LSI chip is integrated, and the miniaturization of a package itself is also strongly demanded. In order to achieve compatibility between the integration of the LSI chip and the miniaturization of the package, development on the semiconductor package suitable to the high-density board mounting of the semiconductor component is strongly demanded. In order to response such demands, various package technologies called as CSP (Chip Size Package) are being developed.

BGA (Ball Grid Array) is well known as an example of such packages. In BGA, the semiconductor chip is mounted on a package board, and solder balls are formed as external terminals in an area array on the opposite surface after the semiconductor chip on the package board is molded with resin. In BGA, because the mounting area is achieved over the surface, the package can be relatively easily miniaturized. Further, the high-accuracy mounting technology is not required because it is unnecessary to be compatible with a narrow pitch on the side of a circuit board. Therefore, even if the package is somewhat expensive, the use of BGA enables the mounting cost to be reduced as a whole.

FIG. 12 is a view showing a schematic configuration of the conventional BGA. BGA 100 has a structure in which an LSI chip 102 is mounted on a glass epoxy board 106 through an adhesive layer 108. The LSI chip 102 is molded by a sealing resin 110. The LSI chip 102 and the glass epoxy board 106 are electrically connected to each other by metal wires 104. Solder balls 112 are arranged in an array on the backside of the glass epoxy board 106. BGA 100 is mounted on a printed wiring board through the solder balls 112.

An example of other CSPs is described in Japanese Patent Laid-Open Publication No. 2002-94247. A system in package on which a high-frequency LSI is mounted is disclosed in Japanese Patent Laid-Open Publication No. 2002-94247. The package includes a base board on which a multilayer wiring structure is formed, and semiconductor devices such as the high-frequency LSI are formed on the base board. The multilayer wiring structure is one in which the core board, a copper foil with dielectric resin layer, a solder resist layer, and the like are laminated.

In the system in package technology including Japanese Patent Laid-Open Publication No. 2002-94247, because the solder resist layer is located on the top layer of the multi-layer wiring structure, high processing accuracy is required. Because the semiconductor device such as a bare chip is directly mounted on the surface of the solder resist layer, high humidity resistance and high adhesion properties are also required. Further, because the solder resist layer acts as an inter-wiring dielectric film between the wiring layers in which wiring patterns are embedded therein, a decrease in parasitic capacitance is required.

Due to the demand for the miniaturization of the package, thickness reduction is required in the solder resist layer.

In the system in package technology including Japanese Patent Laid-Open Publication No. 2002-94247, sometimes the dielectric resin layer differs from the layer which is adjacent to the dielectric resin layer in a linear expansion coefficient and the like. Therefore, in a heat cycle during manufacturing the semiconductor apparatus or during use of the semiconductor apparatus, sometimes there are differences in expansion and contraction levels between the dielectric resin layer and the layers adjacent to the dielectric resin layer. As a result, sometimes a decrease in adhesion properties between the dielectric resin layer and the layers adjacent to the dielectric resin layer is caused. Further, because the dielectric resin layer acts as the inter-wiring dielectric film between the wiring layers in which the wiring patterns are embedded therein, the decrease in parasitic capacitance is required.

Due to the demand for the miniaturization of the package, the thickness reduction is required in a base material or the dielectric resin layer.

In the system in package technology including Japanese Patent Laid-Open Publication No. 2002-94247, the solder resist layer acts as the inter-wiring dielectric film between the wiring layers in which wiring pattern are embedded therein, and the semiconductor device such as the bare chip is directly mounted on the surface of the solder resist layer formed on the top layer. Therefore, it is necessary to improve not only mechanical rigidity and heat-resistant properties but also the parasitic capacitance, the humidity resistance, and the adhesion properties.

### SUMMARY OF THE INVENTION

In view of the foregoing, an object of the invention is to provide a miniaturized device mounting board which has high reliability.

Further, another object of the invention is to provide a highly reliable device mounting board.

In an aspect of the invention, a device mounting board on which a device is mounted, the device mounting board includes a base material, a dielectric film which is provided on the base material, and a solder resist layer which is provided on the dielectric film, wherein the solder resist layer contains a cardo type polymer.

According to the invention, when the solder resist layer contains the cardo type polymer, the characteristics such as resolution and humidity absorption properties can be improved in the solder resist layer. Further, the thickness reduction can also be performed in the solder resist layer. Therefore, the miniaturized device mounting board having high reliability can be provided.

It is possible that wiring for connecting the elements is provided in the solder resist layer.

It is possible that glass transition temperature of the solder resist layer ranges from 180° C. to 220° C. In the case where an alternating electric field having the frequency of 1 MHz is applied to the solder resist layer, it is possible that a dielectric dissipation factor ranges from 0.001 to 0.04.

In a range of not more than the glass transition temperature of the solder resist layer, it is possible that a linear expansion coefficient (CTE) ranges from 50 ppm/° C. to 80 ppm/° C.

According to the invention, the semiconductor apparatus which includes the device mounting board having the above-described features and the semiconductor device mounted on the device mounting board is provided.

According to the invention, the miniaturized semiconductor apparatus having the high reliability can be provided by including the miniaturized device mounting board having the high reliability.

It is possible that the dielectric film is formed by either a single-layer structure or a multi-layer structure.

In the invention, the device mounting board shall mean a board on which the semiconductor device such as an LSI chip and an IC chip is mounted. An interposer board in the later-mentioned ISB (registered trademark) structure can be cited as an example of the device mounting board. It is possible that the device mounting board includes a core board such as a silicon substrate having the rigidity, or it is possible that the device mounting board does not includes the core board but has a core-less structure including the multi-layer dielectric film formed of the dielectric resin films.

### BRIEF DESCRIPTION OF THE DRAWINGS

FIG. 1 is a view for explaining a structure of ISB (registered trademark);

FIG. 2A is a view for explaining a process of manufacturing ISB (registered trademark), and FIG. 2B is a view for explaining a process of manufacturing BGA;

FIGS. 3A and 3B are a process sectional view showing a procedure of manufacturing a device mounting board according to a first embodiment of the invention;

FIGS. 4A to 4C are a process sectional view showing the procedure of manufacturing the device mounting board according to the first embodiment of the invention;

FIGS. 5A and 5B are a process sectional view showing the procedure of manufacturing the device mounting board according to the first embodiment of the invention;

FIGS. 6A to 6C are a process sectional view showing the procedure of manufacturing the device mounting board according to the first embodiment of the invention;

FIGS. 7A and 7B are a process sectional view showing the procedure of manufacturing the device mounting board according to the first embodiment of the invention; FIGS. 8A to 8C are a process sectional view showing the procedure of manufacturing the device mounting board according to the first embodiment of the invention;

FIGS. 9A and 9B are a process sectional view showing the procedure of manufacturing the device mounting board according to the first embodiment of the invention;

FIGS. 10A and 10B are a process sectional view showing the procedure of manufacturing the device mounting board according to the first embodiment of the invention;

FIGS. 11A to 11D are a sectional view for explaining a structure of a semiconductor apparatus according to a second embodiment of the invention;

FIG. 12 shows a schematic configuration of the conventional BGA;

FIGS. 13A and 13B are a process sectional view for explaining a procedure of manufacturing a device mounting board according to Example 1 of a third embodiment;

FIGS. 14A to 14C are a process sectional view for explaining the procedure of manufacturing the device mounting board according to Example 1 of the third embodiment;

FIGS. 15A and 15B are a process sectional view for explaining the procedure of manufacturing the device mounting board according to Example 1 of the third embodiment;

FIGS. 16A to 16C are a process sectional view for explaining the procedure of manufacturing the device mounting board according to Example 1 of the third embodiment; FIGS. 17A and 17B are a process sectional view for explaining the procedure of manufacturing the device mounting board according to Example 1 of the third embodiment;

FIGS. 18A to 18C are a process sectional view for explaining the procedure of manufacturing the device mounting board according to Example 1 of the third embodiment;

FIGS. 19A and 19B are a process sectional view for explaining the procedure of manufacturing the device mounting board according to Example 1 of the third embodiment;

FIGS. 20A and 20B are a process sectional view for showing the procedure of manufacturing the device mounting board according to Example 1 of the third embodiment;

FIGS. 21A to 21D are a sectional view for explaining a structure of a semiconductor apparatus according to Example 2 of the third embodiment;

FIGS. 22A and 22B are a process sectional view for explaining a procedure of manufacturing a device mounting board according to Example 3 of a fourth embodiment;

FIGS. 23A to 23C are a process sectional view for explaining the procedure of manufacturing the device mounting board according to Example 3 of the fourth embodiment;

FIGS. 24A and 24B are a process sectional view for explaining the procedure of manufacturing the device mounting board according to Example 3 of the fourth embodiment;

FIGS. 25A to 25C are a process sectional view for explaining the procedure of manufacturing the device mounting board according to Example 3 of the fourth embodiment;

FIGS. 26A and 26B are a process sectional view for explaining the procedure of manufacturing the device mounting board according to Example 3 of the fourth embodiment;

FIGS. 27A to 27C are a process sectional view for explaining the procedure of manufacturing the device mounting board according to Example 3 of the fourth embodiment;

FIGS. 28A and 28B are a process sectional view for explaining the procedure of manufacturing the device mounting board according to Example 3 of the fourth embodiment;

FIGS. 29A to 29B are a process sectional view for explaining the procedure of manufacturing the device mounting board according to Example 3 of the fourth embodiment; and

FIGS. 30A to 30D are a sectional view for explaining a structure of a semiconductor apparatus according to Example 4 of the fourth embodiment.

### DETAILED DESCRIPTION OF THE PREFERRED EMBODIMENTS

First, an ISB structure adopted in the later-mentioned embodiments will be described. ISB (Integrated System in Board; registered trademark) is a unique package which has developed by the inventors. In packaging an electronic circuit mainly including a semiconductor bare chip, ISB is a unique coreless system in package in which a core (base material) for supporting circuit components while having a wiring pattern made of copper.

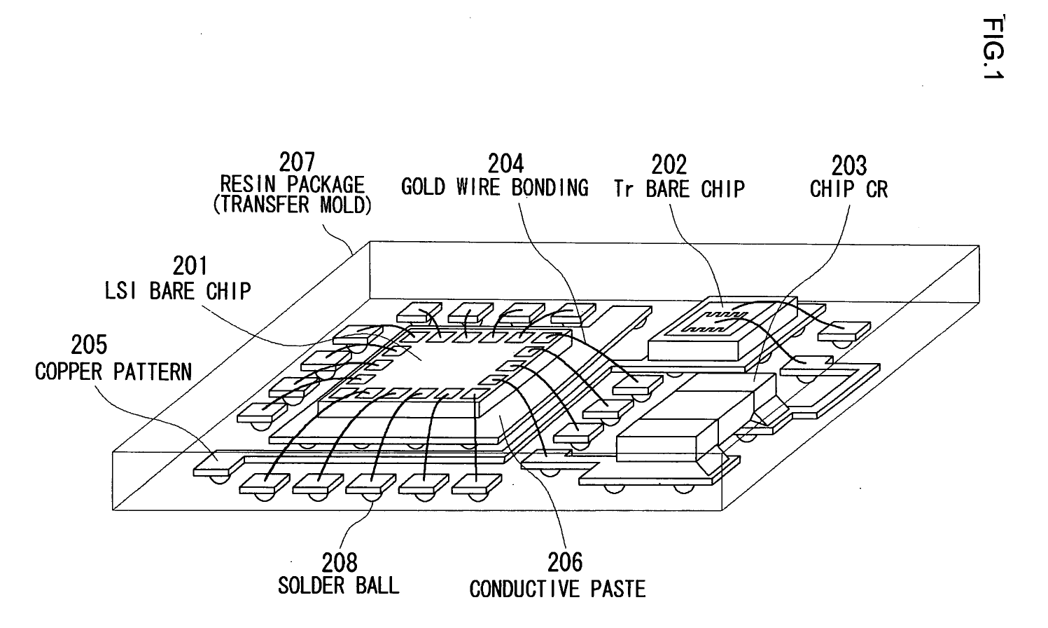

FIG. 1 is a schematic view showing an example of ISB. In order to clearly explain the whole structure of ISB, FIG. 1 shows only a single wiring layer. However, actually ISB has the structure in which the plural wiring layers are laminated. ISB has the structure, in which an LSI bare chip 201, a transistor bare chip 202, and a chip capacitor 203 are connected by the wiring made of a copper pattern 205. The LSI bare chip 201 is electrically connected to lead electrodes and the wiring by gold wire bonding 204. A conductive paste 206 is provided immediately below the LSI bare chip 201, and ISB is mounted on the printed wiring board through the conductive paste 206. The whole of ISB is sealed by a resin package 207 made of epoxy resin or the like.

The package has the following advantages:
(i) The mounting can be performed with no core, so that the miniaturization and the thickness reduction of the transistor, IC, and LSI can be realized.
(ii) The circuit can be formed by the transistor, the system LSI, and the chip type capacitor and resistor to perform the packaging, so that advanced SIP (System in Package) can be realized.
(iii) The current semiconductor devices can be combined, so that the system LSI can be developed within a short period of time.
(iv) The semiconductor bare chip is directly mounted on the copper material being right under, so that good heat dissipation characteristics can be obtained.
(v) The circuit wiring is made of the copper material, and the core material is not used, so that the circuit wiring has a low dielectric constant, which exerts the excellent performance in high-speed data transfer and a high-frequency circuit.
(vi) ISB package has the structure in which the electrode is embedded inside the package, so that particle contamination of the electrode material can be prevented from generating.
(vii) A package size can be freely selected, and an amount of waste material per one package becomes about one-tenth when compared with a 64-pin SQFP package, so that environmental load can be reduced.
(viii) ISB is not the circuit board on which the components are simply mounted, but is the circuit board to which functions are added, so that the new-concept system configuration can be realized.
(ix) Pattern design of ISB is easily performed like the pattern design of the printed circuit board, so that engineers in an electronic-device assembly plant can design the pattern by themselves.

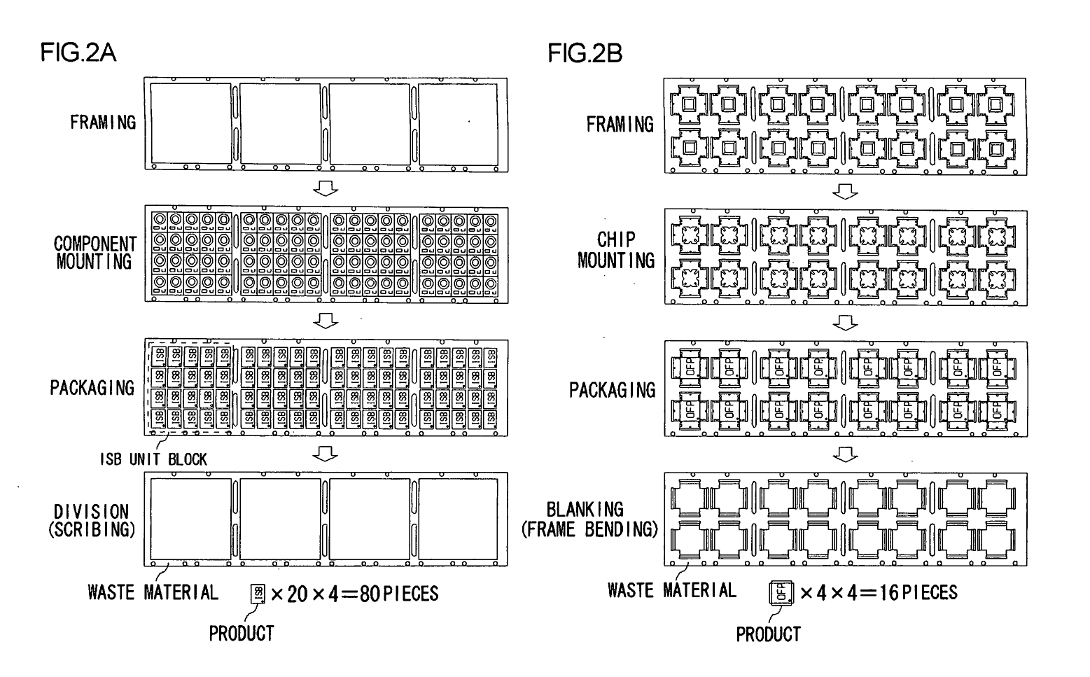

Then, the advantages of the ISB manufacturing process will be described. FIG. 2A shows the ISB manufacturing process, and FIG. 2B shows the conventional CSP manufacturing process. In FIG. 2B, a frame is formed on a base board, and a chip is mounted in an element forming region which is separated into frames. Then, the package is provided for each element by a thermosetting resin, and punching is performed to each element using a punching die. In the punching which is of the final process, because the mold resin and the base board are simultaneously cut, sometimes surface roughening or the like is caused in a cutting plane. Further, sometimes the large amount of waste material is produced after, the punching, so that there is the problem in the environmental load.

On the other hand, FIG. 2A shows the ISB manufacturing process. The frame is provided on a metal foil, the wiring pattern is formed in each module forming region, and the circuit element such as LSI is mounted on the wiring pattern. Then, the packaging is performed to each module, and a product is obtained by dicing the frame along a scribe region. After the packaging is performed, the metal foil which is of the base material is removed prior to the scribing process, so that only the resin layer is cut in the dicing during the scribing process. Therefore, the surface roughening is suppressed in the cutting plane, and accuracy of the dicing can be improved.

First Embodiment

FIG. 10B is a sectional view showing a device mounting board 400 having a four-layer ISB structure according to a first embodiment.

The device mounting board 400 according to the first embodiment has the structure in which an dielectric resin film 312 and a photoimageable solder resist layer 328 are sequentially laminated on an upper surface of a base material 302. The device mounting board 400 also has the structure in which the dielectric resin film 312 and the photoimageable solder resist layer 328 are sequentially laminated on a lower surface of the base material 302.

The four-layer ISB structure shall mean the structure which has the four wiring layers. The wiring layers are embedded in the dielectric resin film 312 and the photoimageable solder resist layer 328. For convenience of a process of making a via hole in the photoimageable solder resist layer 328, it is necessary that the photoimageable solder resist layer 328 has photosensitivity.

In the four-layer ISB structure, the same materials forming the upper and lower surfaces of the dielectric resin layers 312 can be used while sandwiching the base material 302. Further, the same materials forming the upper and lower surfaces of the photoimageable solder resist layers 328 can be used while sandwiching the base material 302. Therefore, from the viewpoint of process, there is the advantage that a manufacturing process can be simplified.

A through-hole 327 which pierces through the base material 302, the dielectric resin film 312, and the photoimageable solder resist layer 328 is made.

A part of the piece of wiring made of a copper film 308, a part of the piece of wiring made of a copper film 320, a part of a via portion 311, and the like are embedded in the base material 302. A part of the piece of the wiring made of the copper film 308, a part of the piece of the wiring made of the copper film 320, wiring 309, a part of the via portion 311, a part of a via portion 323, and the like are embedded in the dielectric resin film 312. A part of the piece of the wiring made of the copper film 320, a part of the via portion 323, and the like are embedded in the photoimageable solder resist layer 328. An opening 326 is provided in the photoimageable solder resist layer 328.

The material used for the base material 302 is not particularly limited to a glass epoxy board, but any material having moderate rigidity can be used as the base material 302. For example, a resin board and a ceramic board can be used as the base material 302. More specifically, the base material which is excellent for the high-frequency characteristics because of the low dielectric constant can be used. Namely, examples of the base material 302 include polyphenyl ethylene (PPE), bismaleimide triazine resins (BT-resin), polytetrafluoro-ethylene (Teflon; registered trademark), polyimide, liquid crystal polymer (LCP), polynorbornene (PNB), epoxy resins, acrylic resins, ceramics, a mixture of ceramic and an organic base material. For example, a thickness of the base material 302 is set to about 60 μm.

The material used for the dielectric resin film 312 is the resin material which is softened by heating and the resin material by which the dielectric resin film 312 can be thinned to a certain level. Particularly the resin material, which has the low dielectric constant and the excellent high-frequency characteristics, can preferably be used. For example, the thickness of the dielectric resin film 312 is set to about 40 μm.

It is possible that the dielectric resin film 312 contains the filling material such as the filler and the fiber. For example, the granular or fibrous SiO₂ or silicon nitride can be used as the filler.

The later-mentioned cardo type polymer contained resin film is used as the photoimageable solder resist layer 328. It is preferable that the thickness of the photoimageable solder resist layer 328 is e.g. not more than about 30 μm, and it is more preferable that the thickness of the photoimageable solder resist layer 328 is about 25 μm.

In the cardo type polymer, a bulky substituent group obstructs movement of a main chain, which results in excellent mechanical strength, excellent heat-resistant properties, and the low linear expansion coefficient. Therefore, in a heat cycle, the decrease in adhesion properties and delamination are suppressed between the photoimageable solder resist layer 328 and the layer around the photoimageable solder resist layer 328 by using the cardo type polymer contained resin film as the photoimageable solder resist layer 328. As a result, the reliability is improved in the device mounting board 400 according to the first embodiment.

The multilayer wiring structure including the wiring formed of copper film 308, the wiring formed of the copper film 320, the wiring 309, the via portion 311, and the via portion 323 is not limited to e.g. copper wiring. For example, aluminum wiring, aluminum alloy wiring, copper alloy wiring, wire-bonded gold wiring, gold alloy wiring, the mixed wiring formed by these pieces of wiring, and the like can also be used as the multilayer wiring structure.

It is also possible that active elements such as the transistor and the diode and passive elements such as the capacitor and the resistor are provided on the surface of or in the four-layer ISB structure. It is also possible that the active elements or the passive elements are connected to a multilayer wiring structure in the four-layer ISB and connected to the external conductive member through the via portion 323.

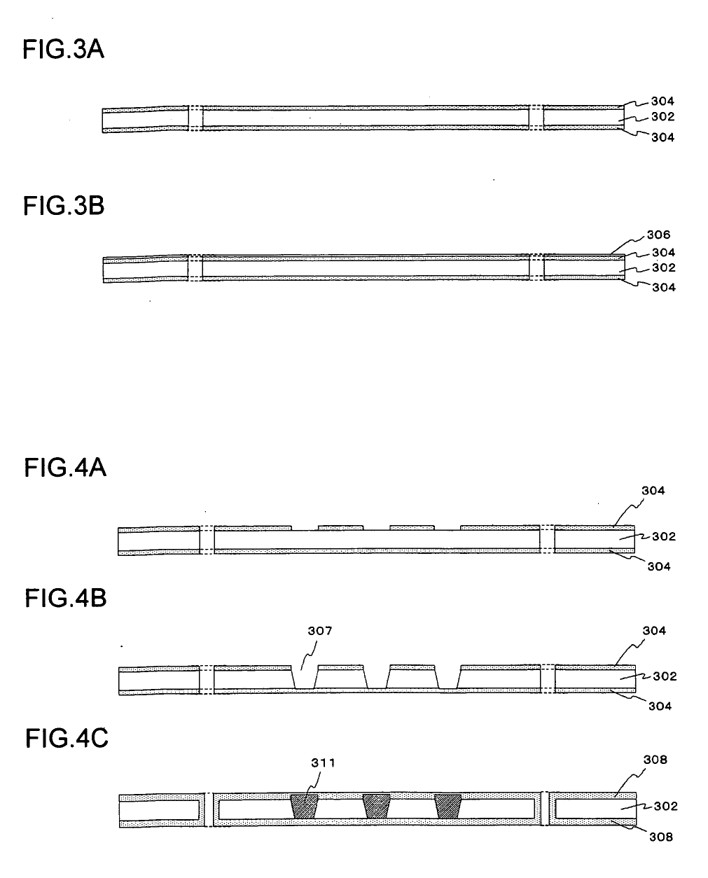

FIGS. 3A to 10B are a process sectional view showing the device mounting board 400 according to the first embodiment.

As shown in FIG. 3A, the base material 302 is prepared. The copper foils 304 are compression-bonded to the base material 302. Holes having diameters of about 150 nm are made in the copper foil 304 by drilling. For example, the thickness of the base material 302 is set to about 60 μm, and the thickness of the copper foil 304 ranges from about 10 μm to about 15 μm. The material used for the base material 302 is not particularly limited to the glass epoxy board, but any material having moderate rigidity can be used as the base material 302. For example, the resin board and the ceramic board can be used as the base material 302. More specifically, the base material which is excellent in the high-frequency characteristics because of the low dielectric constant can be used. Namely, examples of the base material 302 include polyphenyl ethylene (PPE), bismaleimide triazine resins (BT-resin), polytetrafluoro-ethylene (registered trade mark; Teflon), polyimide, liquid crystal polymer (LCP), polynorbornene (PNB), epoxy resins, acrylic resins, ceramics, a mixture of ceramic and an organic base material.

As shown in FIG. 3B, a photo-etching resist layer 306 is laminated on the upper surface of the copper foil 304.

Then, patterning of the photo-etching resist layer 306 is performed by performing exposure with glass as a mask. Then, as shown in FIGS. 4A and 4B, using the photo-etching resist layer 306 as the mask, a via hole 307 having the diameter of about 100 μm is made by chemical etching process using chemicals. Then, the inside of the via hole 307 is roughened and cleaned by a wet process. As shown in FIG. 4C, the via hole 307 is filled with the conductive material to form the via portion 311 by electroless plating ready for high aspect ratio and then by electrolytic plating ready for high aspect ratio. Then, the copper films 308 are formed over the surfaces.

For example, the via portion 311 can be formed in the following manner. After a thin film whose thickness ranges from about 0.5 to about 1 μm is formed over the surface by the electroless copper plating, the film having the thickness of about 20 μm is formed by the electrolytic plating. Usually palladium is used as an electroless plating catalyst. In order to cause the electroless plating catalyst to adhere to the flexible dielectric resin, palladium is contained in an aqueous solution while being in a complex state, and the flexible dielectric base material is dipped to cause the palladium complex to adhere to the surface of the dielectric base material. In the state of things, nuclei for starting the plating onto the surface of the flexible dielectric base material can be formed by reducing the palladium complex to the metal palladium with a reducing agent.

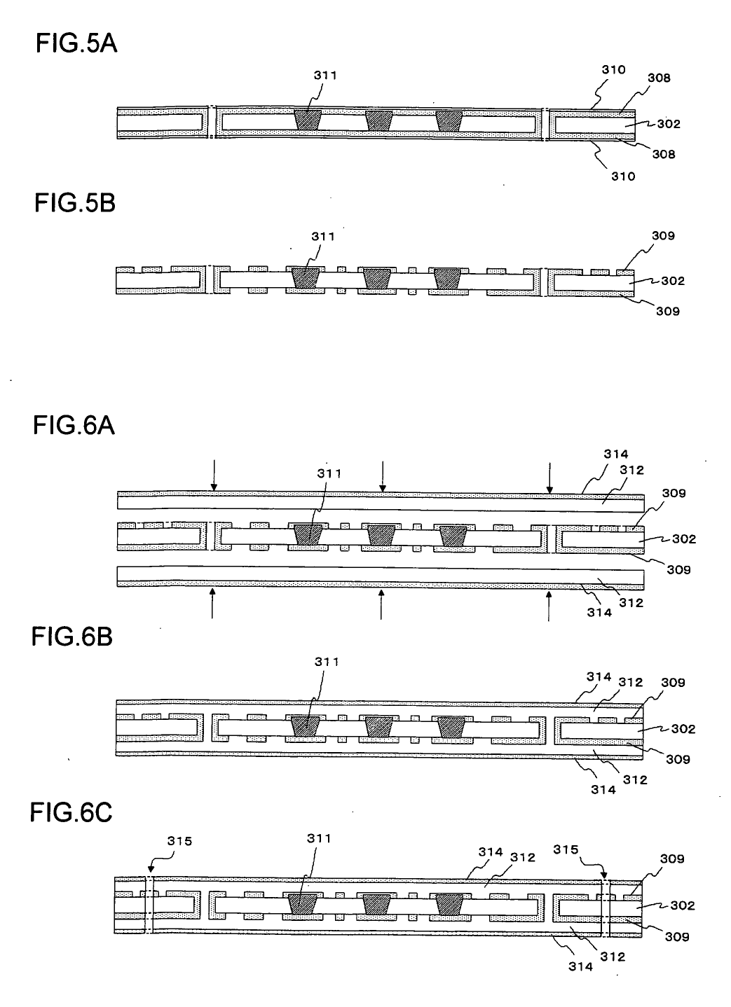

As shown in FIG. 5A, photo-etching resist layers 310 are laminated onto the top surfaces of the upper and lower copper films 308. As shown in FIG. 5B, after the patterning is performed to the photo-etching resist layer 310 by the exposure with glass as the mask, the wiring 309 made of copper is formed by etching the copper film 308 formed of the copper plating layer using the photo-etching resist layer 310 as the mask. For example, the wiring pattern can be formed by spraying a point exposed from the resist with a chemical etching solution to remove the unnecessary copper plating.

As shown in FIG. 6A, dielectric resin films 312 with copper foils 314 are compression-bonded to the top surfaces of the upper wiring 309 and the lower wiring 309. For example, the thickness of the resin film 312 is set to about 40 μm, and the thickness of the copper foil 314 is set in the range from about 10 μm to about 15 μm.

Any material which is softened by the heating can be used as the material used for the dielectric resin film 312. Examples of the dielectric resin film 312 include epoxy resin, melamine derivatives such as BT resin, liquid crystal polymer, PPE resin, polyimide resin, fluororesin, phenolic resin, and polyamide bismaleimide. It is possible that the dielectric resin film 312 contains the filling material such as the filler and the fiber. For example, the granular or fibrous SiO₂ or silicon nitride can be used as the filler.

With reference to the compression-bonding method, the dielectric resin film 312 with copper foil is caused to come into contact with the base material 302 and the wiring 309, and the base material 302 and the wiring 309 are fitted into the dielectric resin film 312. Then, as shown in FIG. 6B, the dielectric resin film 312 is heated in a vacuum or under a reduced pressure to compression-bond the dielectric resin film 312 to the base material 302 and the wiring 309. As shown in FIG. 6C, the copper foil 314 is irradiated with an X-ray to make holes 315 which pierce through the copper foil 314, the dielectric resin film 312, the wiring 309, and the base material 302.

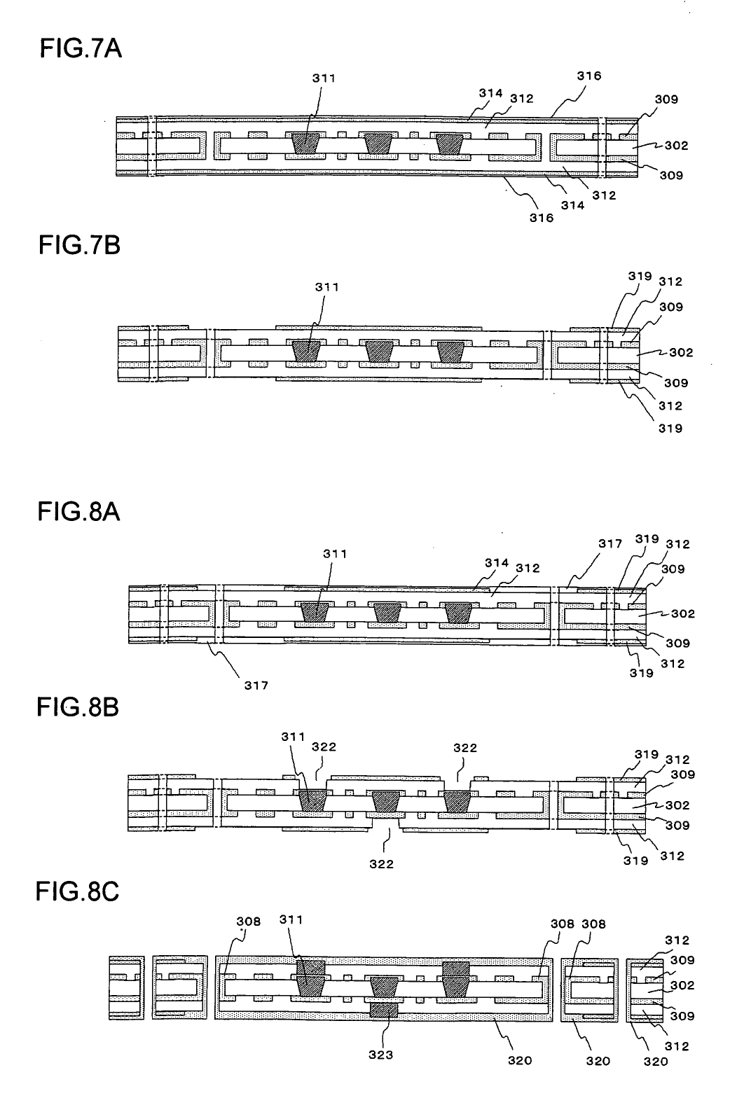

As shown in FIG. 7A, photo-etching resist layers 316 are laminated on the top surfaces of the upper and lower copper foils 314. As shown in FIG. 7B, after the patterning of the photo-etching resist layer 316 is performed by the exposure with the glass as the mask, wiring 319 made of copper is formed by etching the copper foil 314 with the photo-etching resist layer 316 as the mask. For example, the wiring pattern can be formed by spraying a point exposed from the resist with the chemical etching solution to remove the unnecessary copper foil.

As shown in FIG. 8A, a photo-etching resist layer 317 is laminated onto the surfaces of the upper wiring 319 and the lower wiring 319. As shown in FIG. 8B, after the patterning of the photo-etching resist layer 317 is performed by the exposure with the glass as the mask, via holes 322 having the diameters of about 100 nm are made using the photo-etching resist layer 317 as the mask. The inside of the via hole 322 is roughened and cleaned by the wet process. As shown in FIG. 8C, the via hole 322 is filled with the conductive material to form the via portion 323 by the electroless plating ready for high aspect ratio and then by the electrolytic plating ready for high aspect ratio. Then, the copper films 320 are formed over the surfaces.

For example, the via portion 323 can be formed in the following manner. After the thin film whose thickness ranges from about 0.5 to about 1 μm is formed over the surface by the electroless copper plating, the film having the thickness of about 20 μm is formed by the electrolytic plating. Usually palladium is used as the electroless plating catalyst. In order to cause the electroless plating catalyst to adhere to the flexible dielectric resin, palladium is contained in an aqueous solution while being in the complex state, and the flexible dielectric base material is dipped to cause the palladium complex to adhere to the surface of the dielectric base material. In the state of things, the nuclei for starting the plating onto the surface of the flexible dielectric base material can be formed by reducing the palladium complex to the metal palladium with the reducing agent.

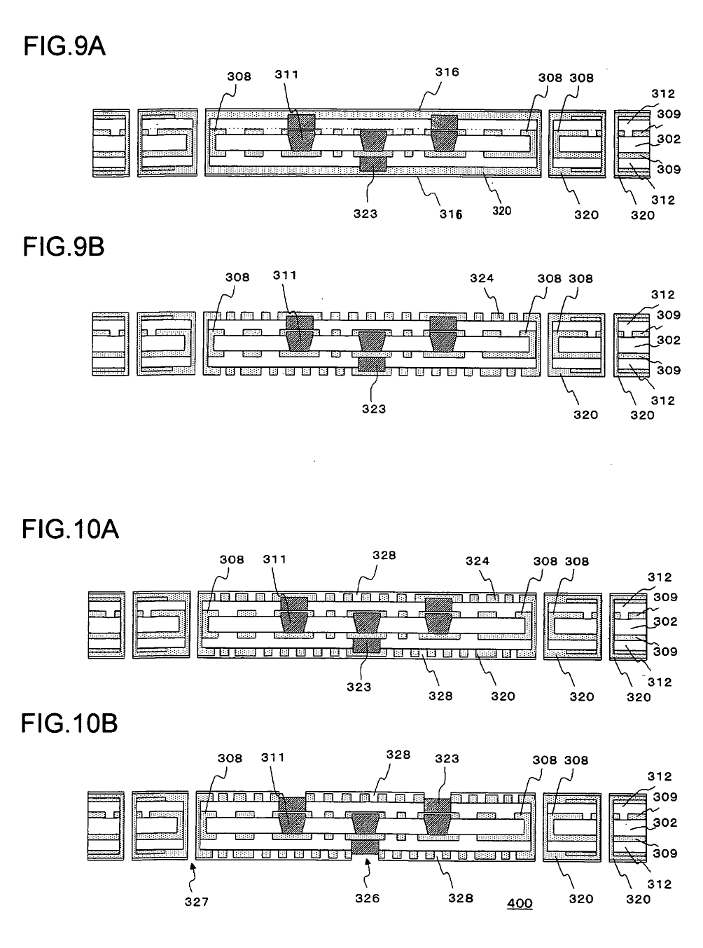

Then, as shown in FIG. 9A, the photo-etching resist layers 316 are laminated onto the top surfaces of the upper and lower copper films 320. As shown in FIG. 9B, after the patterning is performed to the photo-etching resist layer 316 by the exposure with glass as the mask, wiring 324 made of copper is formed by etching the copper film 320 using the photo-etching resist layer 316 as the mask. For example, the wiring pattern can be formed by spraying the point exposed from the resist with the chemical etching solution to remove the unnecessary copper foil.

As shown in FIG. 10A, the photoimageable solder resist layers 328 are laminated onto the top surfaces of the upper and lower wiring 324. At this point, it is preferable that the thickness of the photoimageable solder resist layer 328 is not more than about 30 μm, and it is e.g. more preferable that thickness of the photoimageable solder resist layer 328 is about 25 μm. With reference to the laminating conditions, for example, the temperature is set to 110° C., the time is set in the range from 1 to 2 minutes, and the pressure is set to about 2 atmospheres. Then, the photoimageable solder resist layer 328 is partially cured by an after-baking process.

The cardo type polymers contained resin film later-described is used as the photoimageable solder resist layer 328.

Then, as shown in FIG. 10B, after the patterning is performed to the photoimageable solder resist layer 328 by the exposure with the glass as the mask, the via hole 326 having the diameter of about 100 nm is formed by the chemical etching process using chemicals so that the via portion 323 formed inside the via hole. 322 is exposed. Then, gold plating is performed to the exposed via portion 323 (not shown).

The effect that the cardo type polymer contained resin film is used for the photoimageable solder resist layer 328 in the first embodiment will be described below.

The cardo type polymer is a general term for the polymer having the structure in which a cyclic group is directly bonded to the polymer main chain as shown in Chemical Formula I. Where R₁, and R₂ express bivalent groups such as an alkylene group and a group containing an aromatic ring.
[Chemical Formula I]

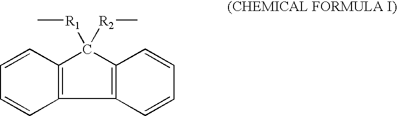

Namely, the cardo type polymer shall mean the polymer having the structure in which the bulky substituent group containing a quaternary carbon atom is substantially perpendicular to the main chain.

It is possible that cyclic portion includes either a saturated bond or an unsaturated bond. In addition to the carbon atom, it is possible that cyclic portion includes atoms such as a nitrogen atom, an oxygen atom, a sulfur atom, and a phosphorus atom. It is possible that the cyclic portion is formed in a polycycle or a fused ring. It is possible that the cyclic portion is bonded to other carbon chains and further cross-linked.

As shown in Chemical Formula I, the cyclic group such as a fluorenyl group which includes the fused ring having the structure, in which six-membered rings are bonded to both sides of a five-membered ring and the remaining one carbon atom of the five-membered ring is bonded to the main chain, can be cited as an example of the bulky substituent group.

As shown in Chemical Formula II, the fluorenyl group is one in which the 9-position carbon atom of fluolene is dehydrogenized. In the cardo type polymer, as shown in Chemical Formula I, the fluorenyl group is bonded to the carbon atom of the alkyl group which is of the main chain at the position of the dehydrogenized carbon atom.
[Chemical Formula II]

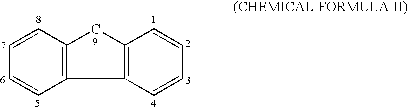

Since the cardo type polymer is one which has the above structure, the cardo type polymer has the following effects:
(1) Rotation constraint of polymer main chain.
(2) Conformation control of main chain and side chain.
(3) Packing obstruction between molecules.
(4) Increase in aromaticity by introducing aromatic substituent group to side chain.

Accordingly, the cardo type polymer has the advantages such as the high mechanical strength, high heat-resistant properties, solvent solubility, high transparency, high refractive index, low birefringence, and higher gas permeability.

The cardo type polymer contained resin film used for the photoimageable solder resist layer 328 can be formed in the thin film while voids and unevenness are prevented from producing by using a predetermined additive. Therefore, the film having the thickness of about 25 μm can be used as the photoimageable solder resist layer 328. The thickness of the film becomes about two-thirds, when compared with the conventional resin material having the thickness of about 35 μm, which is used for the photoimageable solder resist layer. Accordingly, the device mounting board 400 of the first embodiment can be miniaturized by using the cardo type polymer contained resin film as the photoimageable solder resist layer 328. Further, since the film having the thickness of about 25 μm can be used as the photoimageable solder resist layer 328 by using the cardo type polymer contained resin film as the photoimageable solder resist layer 328, the thickness of the photoimageable solder resist layer 328 can be thinned when compared with the dielectric resin film 312 having the thickness of about 40 μm.

As mentioned later, the cardo type polymer contained resin film has the excellent moisture resistance and adhesion properties. Therefore, the adhesion properties between the device mounted on the surface of the device mounting board 400 and other layers can be improved by using the cardo type polymer as the photoimageable solder resist layer 328.

As mentioned later, the cardo type polymer contained resin film has the excellent resolution. Since the thickness of the film used in the first embodiment becomes about two-thirds when compared with the conventional resin material used in the photoimageable solder resist layer, the photoimageable solder resist layer 328 in which the cardo type polymer contained resin film has the further excellent resolution, which allows dimensional accuracy to be improved in making the via hole 326. Therefore, the reliability can be improved in the device mounting board 400.

As mentioned later, the cardo type polymer contained resin film has the excellent dielectric characteristics. Therefore, the parasitic capacitance between pieces of wiring embedded in the photoimageable solder resist layer 328 by using the cardo type polymer contained resin film as the photoimageable solder resist layer 328, which allows the reliability to be improved in the device mounting board 400.

Because the cardo type polymer contained resin film has the high mechanical strength, even if the thickness of the photoimageable solder resist layer 328 is thinned to about two-thirds of the conventional resin material, the mechanical strength can be kept and the warp of the whole of device mounting board 400 can be suppressed. Accordingly, bonding accuracy of the device mounted on the device mounting board 400 can be improved.

A spin coating method usually used for forming the photoimageable solder resist layer still has room for improvement in that the voids are easily produced in outer periphery of the photoimageable solder resist layer. A potting method still has room for improvement in that the voids are easily produced after application because an adhesive is in a liquid state before bonding. On the contrary, in the photoimageable solder resist layer 328 of the first embodiment, because the voids and the unevenness are suppressed to occur during the compression-bonding of the film, the voids and the unevenness are hardly produced in the photoimageable solder resist layer 328 of the device mounting board 400 to which the film is compression-bonded. Therefore, the reliability and production stability of the device mounting board 400 can be improved.

It is also possible that the cardo type polymer is one which is formed of the cross-linked polymer having the carboxylic group and the acrylate group in the same molecular chain. Conventionally, a blend of a carboxyl group oligomer having development properties and a polyfunctional acryl is used as the general photosensitive varnish. However, the general photosensitive varnish still has room for improvement in the resolution. When the cardo type polymer formed of the cross-linked polymer having the carboxyl group and the acrylate group in the same molecular chain is used instead of the general photosensitive varnish, the cardo type polymer has the carboxyl group having the development properties and the acrylate group which is of the crosslinking group in the same molecular chain, and the cardo type polymer also has the bulky substituent group in the main chain, so that the radical diffusion is difficult to occur. Therefore, in the cardo type polymer contained photoimageable solder resist film, there is the advantage that the resolution is improved.

It is desirable that the cardo type polymer contained resin film satisfies the following physical properties. The following physical properties are the value for the resin portion which does not include the filler and the like, and the physical properties can be appropriately adjusted by adding the filler and the like.

In the cardo type polymer contained resin film, it is preferable that the glass transition temperature (Tg) is e.g. not lower than 180° C., and it is more preferable that Tg is not lower than 190° C. When Tg exists in the above range, the heat-resistant properties are improved in the cardo type polymer contained resin film.

In the cardo type polymer contained resin film, it is preferable that Tg is e.g. not more than 220° C., it is more preferable that Tg is not more than 210° C. When Tg exists in the above range, the cardo type polymer contained resin film can stably be produced by the usual manufacturing method. Tg can be measured by dynamic viscoelasticity measurement (DMA).

In the range of not more than Tg of the cardo type polymer contained resin film, it is preferable that the linear expansion coefficient (CTE) of the cardo type polymer contained resin film is e.g. not more than 80 ppm/° C., and it is more preferable that CTE is not more than 75 ppm/° C. When CTE exists in the above range, the adhesion properties between the cardo type polymer contained resin film and other members are improved.

In the range of not more than Tg of the cardo type polymer contained resin film, it is preferable that CTE of the cardo type polymer contained resin film is e.g. not lower than 50 ppm/° C., and it is more preferable that CTE is not lower than 55 ppm/° C. Further, the resin composition having CTE of not more than 20 ppm/° C. can be obtained by mixing the filler in the cardo type polymer contained resin film. When CTE exists in the above range, the cardo type polymer contained resin film can stably be produced by the usual manufacturing method. CTE can be measured according to the thermal expression measurement by a thermo-mechanical analysis apparatus (TMA).

It is preferable that heat conductivity of the cardo type polymer contained resin film is e.g. not more than 0.50 W/cm²·sec, and it is more preferable that the heat conductivity is not more than 0.35 W/cm²·sec. When the heat conductivity exists in the above range, the heat-resistant properties are improved in the cardo type polymer contained resin film.

It is preferable that the heat conductivity of the cardo type polymer contained resin film is e.g. not lower than 0.10 W/cm²·sec, and it is more preferable that the heat conductivity is not lower than 0.25 W/cm²·sec. When the heat conductivity exists in the above range, the cardo type polymer contained resin film can stably be produced by the usual manufacturing method. For example, the heat conductivity can be measured by a disk heat flow meter method (ASTM E1530).

In the via portion which has the diameter ranging from 10 to 100 μm in the cardo type polymer contained resin film, it is preferable that a via aspect ratio is e.g. not lower than 0.5, and it is more preferable that the via aspect ratio is not lower than 1. When the via aspect ratio exists in the above range, the resolution is improved in the cardo type polymer contained resin film.

In the via portion which has the diameter ranging from 10 to 100 μm in the cardo type polymer contained resin film, it is preferable that the via aspect ratio is e.g. not more than 5, and it is more preferable that the via aspect ratio is not more than 2. When the via aspect ratio exists in the above range, the cardo type polymer contained resin film can stably be produced by the conventional manufacturing method.

In the case where an alternating electric field having the frequency of 1 MHz is applied to the cardo type polymer contained resin film, it is preferable that the dielectric constant of the cardo type polymer contained resin film is e.g. not more than 4, and it is more preferable that the dielectric constant is not more than 3. When the dielectric constant exists in the above range, dielectric characteristics such as high-frequency characteristics are improved in the cardo type polymer contained resin film.

In the case where the alternating electric field having the frequency of 1 MHz is applied to the cardo type polymer contained resin film, it is possible that the dielectric constant is e.g. not lower than 0.1, and it is more preferable that the dielectric constant is not lower than 2.7. When the dielectric constant exists in the above range, the cardo type polymer contained resin film can stably be produced by the conventional manufacturing method.

In the case where the alternating electric field having the frequency of 1 MHz is applied to the cardo type polymer contained resin film, it is preferable that a dielectric dissipation factor is e.g. not more than 0.04, and it is more preferable that the dielectric dissipation factor is not more than 0.029. When the dielectric dissipation factor exists in the above range, the dielectric characteristics such as the high-frequency characteristics are improved in the cardo type polymer contained resin film.

In the case where the alternating electric field having the frequency of 1 MHz is applied to the cardo type polymer contained resin film, it is preferable that the dielectric dissipation factor is e.g. not lower than 0.001, and it is more preferable that the dielectric dissipation factor is not lower than 0.027. When the dielectric dissipation factor exists in the above range, the cardo type polymer contained resin film can stably be produced by the conventional manufacturing method.

In the cardo type polymer contained resin film, it is preferable that 24-hour water absorption (wt %) is e.g. not more than 3 wt %, and it is more preferable that the 24-hour water absorption (wt %) is not more than 1.5 wt %. When the 24-hour water absorption exists in the above range, moisture resistance can be improved in the cardo type polymer contained resin film.

In the cardo type polymer contained resin film, it is preferable that 24-hour water absorption (wt %) is e.g. not lower than 0.5 wt %, and it is more preferable that the 24-hour water absorption (wt %) is not lower than 1.3 wt %. When the 24-hour water absorption exists in the above range, the cardo type polymer contained resin film can stably be produced by the conventional manufacturing method.

The characteristics such as the thinning of film, the mechanical strength, the heat-resistant properties, the adhesion properties to other members, the resolution, the dielectric characteristics, and the moisture resistance are required for the photoimageable solder resist layer 328 for which the cardo type polymer contained resin film is used. The characteristics required for the photoimageable solder resist layer 328 are realized in a well-balanced manner, when the cardo type polymer contained resin film satisfies the above physical properties.

Second Embodiment

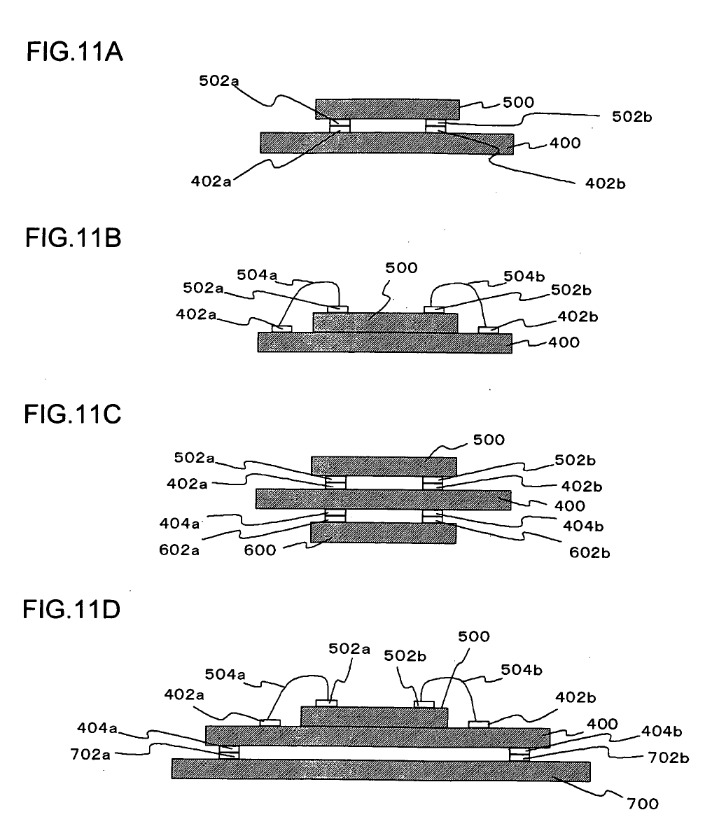

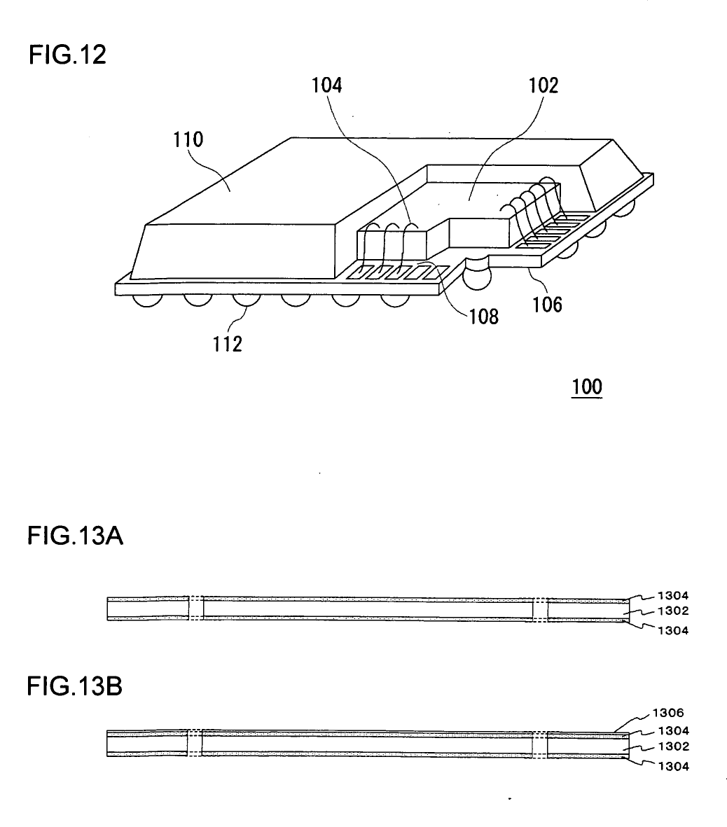

FIG. 11 is a sectional view schematically showing various methods of mounting the semiconductor device on the device mounting board 400 including a four-layer ISB structure according to a second embodiment.

In the second embodiment, the cardo type polymer contained resin film is equal to the cardo type polymer contained resin film described in the first embodiment.

There are various modes in the semiconductor apparatus which is formed by mounting the semiconductor device on the device mounting board 400 described in the first embodiment. For example, there is the mode in which the semiconductor device is mounted on the device mounting board 400 by the flip chip connection or the wire bonding connection. There is the mode in which the semiconductor device is mounted on the device mounting board 400 by taking a face up structure or a face down structure. There is the mode in which the semiconductor device is mounted on one side or both sides of the device mounting board 400 . Further, there is the mode in which these various modes are combined.

Specifically, as shown in FIG. 11A, a semiconductor device 500 such as LSI can be mounted on a device mounting board 400 of the first embodiment in the flip chip form. At this point, electrode pads 402a and 402b on the device mounting board 400 are directly connected to electrode pads 502a and 502b of the semiconductor device 500 respectively.

As shown in FIG. 11B, the semiconductor device 500 such as LSI can be mounted on the device mounting board 400 by taking the face up structure. At this point, the electrode pads 402a and 402b located on the top of the device mounting board 400 are connected to the electrode pads 502a and 502b located on the top of the semiconductor device 500 by the wire bonding connection respectively.

As shown in FIG. 11C, the semiconductor device 500 such as LSI can be mounted on the device mounting board 400 in the flip chip form, and a semiconductor device 600 such as IC can be mounted beneath the device mounting board 400 in the flip chip form. At this point, the electrode pads 402a and 402b located on the top of the device mounting board 400 are directly connected to the electrode pads 502a and 502b of the semiconductor device 500 respectively. Further, the electrode pads 404a and 404b located on the lower surface of the device mounting board 400 are directly connected to electrode pads 602a and 602b of the semiconductor device 600 respectively.

As shown in FIG. 11D, the semiconductor device 500 such as LSI can be mounted on the device mounting board 400 by taking the face up structure, and the device mounting board 400 can be mounted on a printed board 700. At this point, the electrode pads 402a and 402b located on the top of the device mounting board 400 are connected to the electrode pads 502a and 502b located on the top of the semiconductor device 500 through gold wires 504a and 504b by wire bonding connection respectively. Further, the electrode pads 404a and 404b located on the lower surface of the device mounting board 400 are directly connected to electrode pads 702a and 702b located on the top of the printed board 700 respectively.

As described in the first embodiment, the device mounting board 400 in which the cardo type polymer contained resin film is used as the photoimageable solder resist layer 328 is used in the semiconductor apparatus formed by any structure described above. The cardo type polymer contained resin film is excellent in the characteristics such as the moisture resistance, the adhesion properties, the dielectric characteristics, and the resolution. Therefore, the cardo type polymer contained resin film is excellent in the adhesion properties to the dielectric resin film 312 which is in contact with the photoimageable solder resist layer 328, the dimensional accuracy can be improved when the via hole is made in the photoimageable solder resist layer 328, and the parasitic capacitance can be decreased. Further, because the film, which has the high mechanical strength even if the film is thinned, is used for the photoimageable solder resist layer 328, the warp of the whole of device mounting board 400 can be suppressed, which improves the accuracy when the device is mounted on the device mounting board 400. Accordingly, mounting the device on the device mounting board 400 can provide the miniaturized semiconductor apparatus having the high reliability.

The invention is not limited to the second embodiment, and it is understood that those skilled in the art could modify the second embodiment without departing from the scope of the invention.

For example, in addition to the photoimageable solder resist layer 328, it is possible that the cardo type polymer contained resin film is used for the base material 302 or the dielectric resin film 312.

When the cardo type polymer contained resin film is used as the base material 302 in addition to the photoimageable solder resist layer 328, the following effects can be obtained.

The cardo type polymer contained resin film used for the base material 302 can be formed into the thin film while the voids and the unevenness are suppressed to occur by using the predetermined additive. Therefore, the film having the thickness of about 40 μm can be used as the base material 302. The thickness of the film becomes about two-thirds, when compared with the conventional resin material having the thickness of about 60 μm, which is used for the base material. Accordingly, the device mounting board 400 of the first embodiment can further be miniaturized while the reliability is further improved by using the cardo type polymer contained resin film as the base material 302 in addition to the photoimageable solder resist layer 328. Further, the reliability is further improved by mounting the semiconductor device on the device mounting board 400, which allows the further miniaturized semiconductor apparatus to be provided.

When the cardo type polymer contained resin film is used as the dielectric resin film 312 in addition to the photoimageable solder resist layer 328, the following effects can be obtained.

The cardo type polymer contained resin film used for the dielectric resin film 312 can be formed in the thin film while the voids and the unevenness are suppressed to occur by using the predetermined additive. Therefore, the film having the thickness of about 25 μm can be used as the dielectric resin film 312. The thickness of the film becomes about two-thirds, when compared with the conventional resin material having the thickness of about 40 μm, which is used for the conventional dielectric resin film. Accordingly, the device mounting board 400 can further be miniaturized by using the cardo type polymer contained resin film as the dielectric resin film 312 in addition to the photoimageable solder resist layer 328. As described above, since the cardo type polymer contained resin film is excellent in the adhesion properties, the heat-resistant properties, the dielectric characteristics, and the like, interlayer adhesion properties are improved in the dielectric resin film 312, which decreases the parasitic capacitance. Therefore, the reliability can be improved in the device mounting board 400. Further, since the voids and the unevenness are suppressed to occur during the compression-bonding of the film, the voids and the unevenness are hardly produced in the dielectric resin film 312 of the device mounting board 400 to which the film is compression-bonded. Therefore, the device mounting board 400 can further be miniaturized while the reliability is improved by using the cardo type polymer contained resin film as the dielectric resin film 312 in addition to the photoimageable solder resist layer 328. Further, the reliability and the production stability are remarkably improved by mounting the semiconductor device on the device mounting board 400, which allows the further miniaturized semiconductor apparatus to be provided.

In addition to the photoimageable solder resist layer 328, it is possible that the cardo type polymer contained resin film is used for the base material 302 and the dielectric resin film 312.

The cardo type polymer contained resin film is excellent in the characteristics such as the heat resistant properties, the mechanical strength, the adhesion properties, the moisture resistance properties, the dielectric characteristics, and the resolution, and the cardo type polymer contained resin film can be formed in the thin film. Therefore, the base material 302, the dielectric resin film 312, and the photoimageable solder resist layer 328 are excellent in the characteristics such as the rigidity, the heat-resistant properties, the interlayer adhesion properties, the parasitic capacitance, the dimensional accuracy in mounting the device, and flatness. As a result, by using the cardo type polymer contained resin film as the base material 302 and the dielectric resin film 312 in addition to the photoimageable solder resist layer 328, the reliability and the production stability of the device mounting board 400 can remarkably be improved, and the device mounting board 400 can further be miniaturized. Further, the reliability and the production stability are remarkably improved by mounting the semiconductor device on the device mounting board 400, which allows the further miniaturized semiconductor apparatus to be provided.

In the second embodiment, the cardo type polymer contained resin film is used as the photoimageable solder resist layer 328 constituting the device mounting board 400 including the four-layer ISB structure. Further, it is possible that the cardo type polymer contained resin film is used as the photoimageable solder resist layer of the device mounting board including the ISB structure which includes at least four wiring layers, e.g. six wiring layers. It is also possible that the cardo type polymer contained resin film is used for the photoimageable solder resist layer of other semiconductor packages.

Third Embodiment

In an aspect of a third embodiment, a device mounting board on which a device is mounted, the device mounting board includes a base material and a dielectric film which is provided on the base material, wherein the base material contains a cardo type polymer.

According to the third embodiment, the base material contains the cardo type polymer, which allows the base material to be thinned while the rigidity is maintained. Therefore, the miniaturized device mounting board having the high reliability can be provided.

In another aspect of the third embodiment, a device mounting board on which a device is mounted, the device mounting board includes a base material and a dielectric film which is provided on the base material, wherein the dielectric film contains a cardo type polymer.

According to the third embodiment, when the dielectric film contains the cardo type polymer, the interlayer adhesion properties between the dielectric film and the layers adjacent to the dielectric film are improved, and the parasitic capacitance between the pieces of wiring is decreased, so that the reliability can be improved. Further, the thickness reduction can also be performed on the dielectric film. Therefore, the miniaturized device mounting board having high reliability can be provided.

It is possible that glass transition temperature of the base material ranges from 180° C. to 220° C. In the case where the alternating electric field having the frequency of 1 MHz is applied to the base material, it is possible that the dielectric dissipation factor of the base material ranges from 0.001 to 0.04.

In the range not more than the glass transition temperature of the base material, it is possible that the linear expansion coefficient of the base material ranges from 50 ppm/° C. to 80 ppm/° C.

It is possible that glass transition temperature of the dielectric film ranges from 180° C. to 220° C. In the case where the alternating electric field having the frequency of 1 MHz is applied to the dielectric film, it is possible that the dielectric dissipation factor of the dielectric film ranges from 0.001 to 0.04.

In the range not more than the glass transition temperature of the dielectric film, it is possible that the linear expansion coefficient of the dielectric film ranges from 50 ppm/° C. to 80 ppm/° C.

It is possible that the wiring for connecting the devices is provided on the dielectric film.

It is possible that a second dielectric film is provided on the dielectric film and the wiring is covered with the second dielectric film.

It is possible that the second dielectric film contains the cardo type polymer.

It is possible that the glass transition temperature of the second dielectric film ranges from 180° C. to 220° C. In the case where the alternating electric field having the frequency of 1 MHz is applied to the second dielectric film, it is possible that the dielectric dissipation factor of the second dielectric film ranges from 0.001 to 0.04.

In the range not more than the glass transition temperature of the second dielectric film, it is possible that the linear expansion coefficient of the second dielectric film ranges from 50 ppm/° C. to 80 ppm/° C.

According to the third embodiment, the semiconductor apparatus which includes any one of the above device mounting boards and the semiconductor device mounted on the device mounting board is provided.

According to the third embodiment, the miniaturized semiconductor apparatus having the high reliability can be provided by including the miniaturized device mounting board having the high reliability.

It is possible that the dielectric film is formed by either the single-layer structure or the multi-layer structure.

In the third embodiment, the device mounting board shall mean the board on which the semiconductor device such as the LSI chip and the IC chip is mounted. The interposer board in the later-mentioned ISB (registered trademark) structure can be cited as an example of the device mounting board. It is possible that the device mounting board includes the core board such as a silicon substrate having the rigidity, or it is possible that the device mounting board does not includes the core board but has the core-less structure including the multi-layer dielectric film formed by the dielectric resin films.

### EXAMPLE 1

FIG. 20B is a sectional view showing the device mounting board 1400 including the four-layer ISB structure according to Example 1.

The device mounting board 1400 has the structure in which an dielectric resin film 1312 and a photoimageable solder resist layer 1328 are sequentially laminated on the upper surface of a base material 1302. The device mounting board also has the structure in which the dielectric resin film 1312 and the photoimageable solder resist layer 1328 are sequentially laminated on the lower surface of the base material 1302.

The four-layer ISB structure shall mean the structure which has the four wiring layers. The wiring layers are embedded in the dielectric resin film 1312 and the photoimageable solder resist layer 1328. For convenience of the process of making the via hole in the photoimageable solder resist layer 1328, it is necessary that the photoimageable solder resist layer 1328 has the photosensitivity.

In the four-layer ISB structure, the same materials forming the upper and lower surfaces of the dielectric resin layers 1312 can be used while sandwiching the base material 1302. Further, the same materials forming the upper and lower surfaces of the photoimageable solder resist layers 1328 can be used while sandwiching the base material 1302. Therefore, from the viewpoint of process, there is the advantage that the manufacturing process can be simplified.

A through-hole 1327 which pierces through the base material 1302, the dielectric resin film 1312, and the photoimageable solder resist layer 1328 is made.

A part of the piece of wiring made of a copper film 1308, a part of the piece of wiring made of a copper film 1320, a part of a via portion 1311, and the like are embedded in the base material 1302. A part of the piece of the wiring made of the copper film 1308, a part of the piece of the wiring made of the copper film 1320, wiring 1309, a part of the via portion 1311, a part of a via portion 1323, and the like are embedded in the dielectric resin film 1312. A part of the piece of the wiring made of the copper film 1320, a part of the via portion 1323, and the like are embedded in the photoimageable solder resist layer 1328. An opening 1326 is provided in the photoimageable solder resist layer 1328.

The cardo type polymer contained resin film is used as the base material 1302. For example, the thickness of the base material 1302 is set to about 40 μm.

The resin material used for the dielectric resin film 1312 is one which is softened by the heating, and the cardo type polymer contained resin film later-described is used as the dielectric resin film 1312. It is possible that the dielectric resin film 1312 contains the filling material such as the filler and the fiber. For example, the granular or fibrous SiO₂ or SiN can be used as the filler. For example, the thickness of the dielectric resin film 1312 is set to about 25 μm.

It is possible that the later-described cardo type polymer contained resin film and the like are used as the photoimageable solder resist layer 1328.

In the cardo type polymer, the bulky substituent group obstructs the movement of the main chain, which results in the excellent mechanical strength, the excellent heat-resistant properties, and the low linear expansion coefficient. Therefore, in the heat cycle, the decrease in adhesion properties, the delamination or the like is suppressed among the base material 1302, the dielectric resin film 1312, and the photoimageable solder resist layer 1328 by using the cardo type polymer contained resin film for the base material 1302, the dielectric resin film 1312 and the photoimageable solder resist layer 1328. As a result, the reliability is improved in the device mounting board 1400 according to Example 1. Further, the cardo type polymer contained resin film which can be formed into the thin film is used as the base material 1302, the dielectric resin film 1312, and the photoimageable solder resist layer 1328, thereby the miniaturization can be realized in the device mounting board 1400 according to Example 1.

The multilayer wiring structure including the wiring formed of copper film 1308, the wiring formed of the copper film 1320, the wiring 1309, the via portion 1311 and the via portion 1323 is not limited to the copper wiring. For example, the aluminum wiring, the aluminum alloy wiring, the copper alloy wiring, the wire-bonded gold wiring, the gold alloy wiring, the wiring formed of these pieces of wiring, and the like can also be used as the multilayer wiring structure.

It is also possible that active elements such as the transistor and the diode and passive elements such as the capacitor and the resistor are provided on the surface of or in the four-layer ISB structure. It is also possible that the active elements or the passive elements are connected to the multilayer wiring structure in the four-layer ISB and connected to the external conductive member through the via portion 1323.

FIGS. 13A to 20B are a process sectional view showing the device mounting board 1400 which includes the four-layer ISB structure according to Example 1.

As shown in FIG. 13A, the base material 1302 is prepared. The copper foils 1304 are compression-bonded to the base material 1302. The holes having diameters of about 150 μm are made by a drill in the copper foil 1304. At this point, the thickness of the base material 1302 is set to about 40 μm, and the thickness of the copper foil 1304 ranges from about 10 μm to about 15 μm.

The cardo type polymer contained resin film later-described is used as the base material 1302.

As shown in FIG. 13B, a photo-etching resist layer 1306 is laminated on the upper surface of the copper foil 1304.

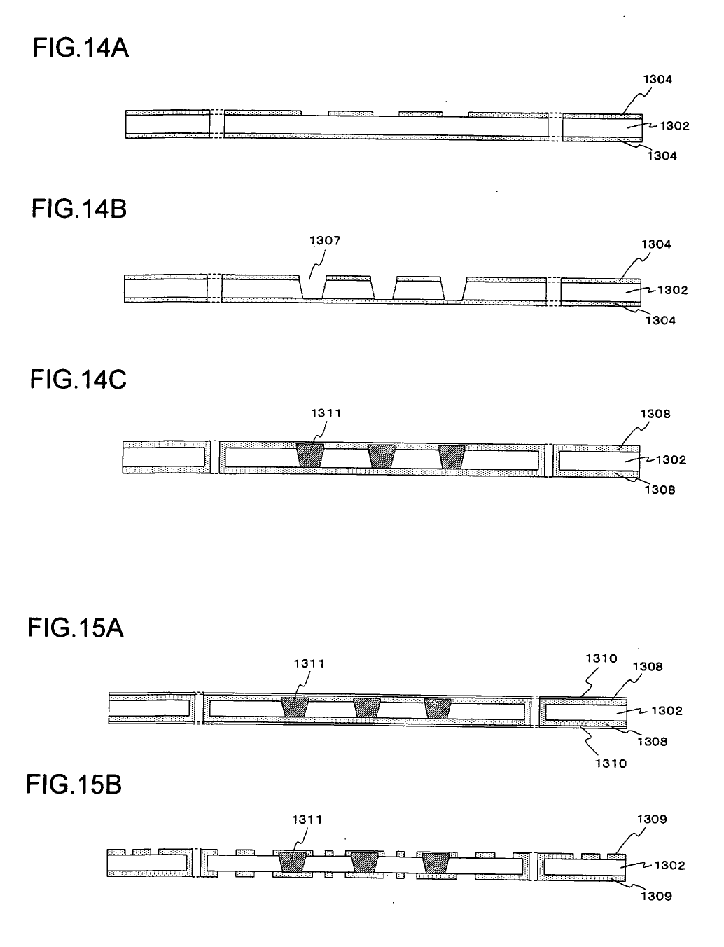

Then, the patterning is performed to the photo-etching resist layer 1306 by the exposure with the glass as the mask. As shown in FIGS. 14A and 14B, via holes 1307 having the diameters of about 100 nm are made by the chemical etching process using chemicals while using the photo-etching resist layer 1306 as the mask. Then, the inside of the via hole 1307 is roughened and cleaned by the wet process. As shown in FIG. 14C, the via hole 1307 is filled with the conductive material to form the via portion 1311 by the electroless plating ready for high aspect ratio and then by the electrolytic plating ready for high aspect ratio. Then, the copper films 1308 are formed over the surfaces.

For example, the via portion 1311 can be formed in the following manner. After the thin film whose thickness ranges from about 0.5 to about 1 μm is formed over the surface by the electroless copper plating, the film having the thickness of about 20 μm is formed by the electrolytic plating. Usually palladium is used as the electroless plating catalyst. In order to cause the electroless plating catalyst to adhere to the flexible dielectric resin, palladium is contained in the aqueous solution while being in the complex state, and the flexible dielectric base material is dipped to cause the palladium complex to adhere to the surface of the dielectric base material. In the state of things, the nuclei for starting the plating onto the surface of the flexible dielectric base material can be formed by reducing the palladium complex to the metal palladium with the reducing agent.

As shown in FIG. 15A, photo-etching resist layers 1310 are laminated onto the top surfaces of the upper and lower copper films 1308. Then, as shown in FIG. 15B, the patterning is performed on the photo-etching resist layer 1310 by performing the exposure with glass as the mask, and the wiring 1309 made of copper is formed by etching the copper film 1308 formed of the copper plating layer using the photo-etching resist layer 1310 as the mask. For example, the unnecessary copper plating is removed to form the wiring pattern by spraying the point exposed from the resist with the chemical etching solution.

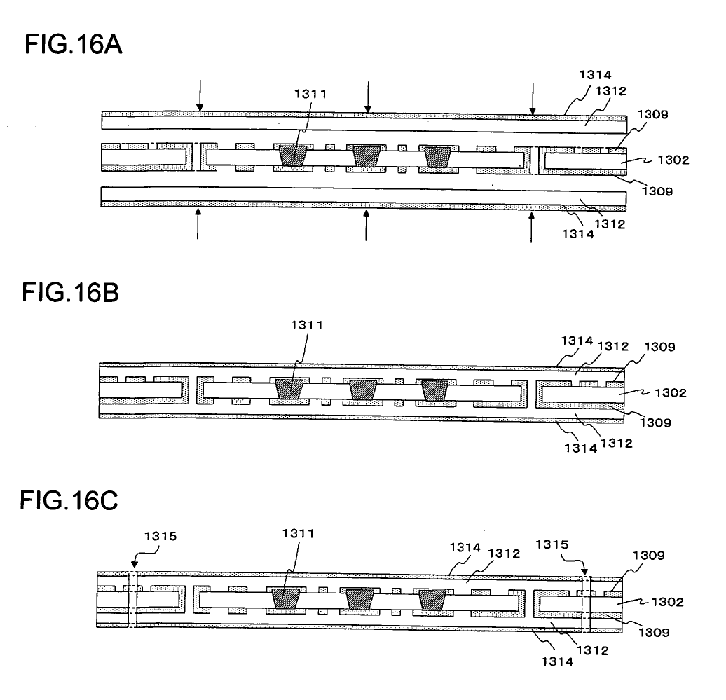

As shown in FIG. 16A, the dielectric resin films 1312 with copper foils 1314 are compression-bonded to the top surfaces of the upper wiring 1309 and the lower wiring 1309. For example, the thickness of the dielectric resin film 1312 is set to e.g. about 25 μm, and the thickness of the copper foil 1314 ranges e.g. from about 10 μm to about 15 μm.

The dielectric resin film 1312 is one of resin materials which is softened by the heating, and the later-described cardo type polymer contained resin film is used as the resin material. It is possible that the dielectric resin film 312 contains the filling material such as the filler and the fiber. For example, the granular or fibrous SiO₂ or SiN can be used as the filler.

In the compression-bonding method; the dielectric resin film 1312 with copper foil is caused to come into contact with the base material 1302 and the wiring 1309, and the base material 1302 and the wiring 1309 are fitted into the dielectric resin film 1312. Then, as shown in FIG. 16B, the dielectric resin film 1312 is heated in the vacuum or under the reduced pressure to compression-bond the dielectric resin film 1312 to the base material 1302 and the wiring 1309. Then, as shown in FIG. 16C, the copper foil 1314 is irradiated with the X-ray to make holes 1315 which pierce through the copper foil 1314, the dielectric resin film 1312, the wiring 1309, and the base material 1302.

As shown in FIG. 17A, photo-etching resist layers 1316 are laminated on the top surfaces of the upper and lower copper foils 314. As shown in FIG. 17B, the patterning is performed on the photo-etching resist layer 1316 by the exposure with the glass as the mask, and wiring 1319 made of copper is formed by etching the copper foil 1314 with the photo-etching resist layer 1316 as the mask. For example, the wiring pattern can be formed by spraying the point exposed from the resist with the chemical etching solution to remove the unnecessary copper foil.

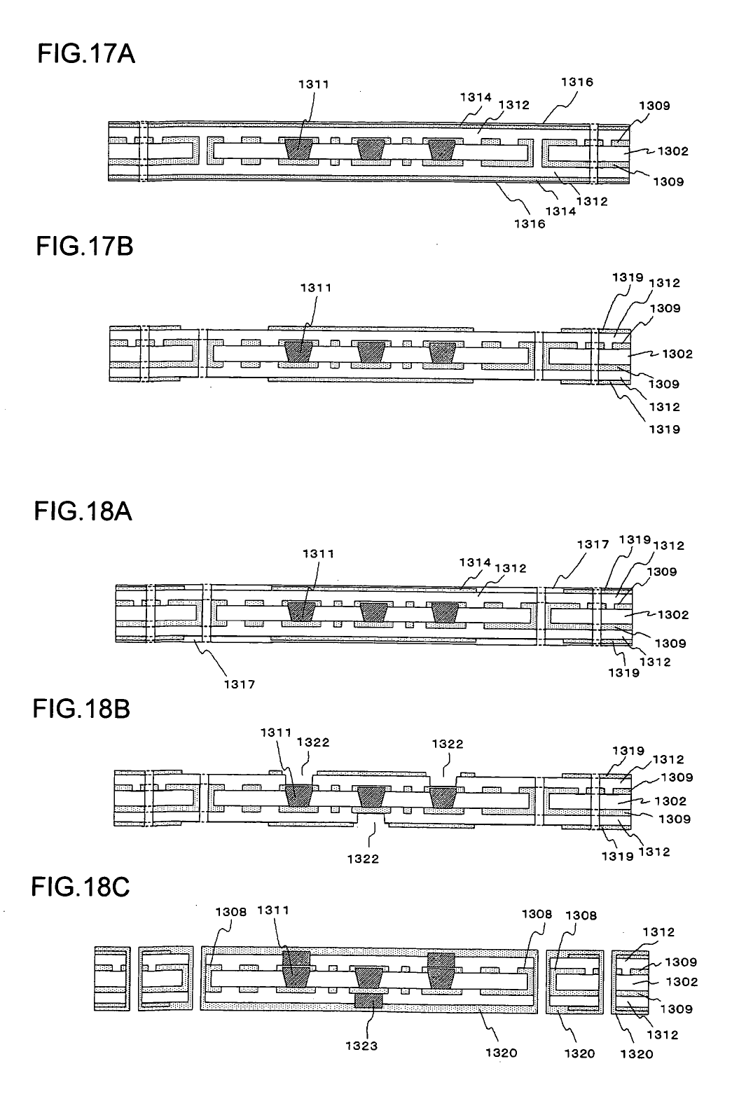

As shown in FIG. 18A, photo-etching resist layers 1317 are laminated onto the surfaces of the upper wiring 1319 and the lower wiring 1319. As shown in FIG. 18B, after the patterning is performed on the photo-etching resist layer 1317 by the exposure with the glass as the mask, via holes 1322 having the diameters of about 100 nm are made by the chemical etching with chemicals using the photo-etching resist layer 1317 as the mask. Then, the inside of the via hole 1322 is roughened and cleaned by the wet process. As shown in FIG. 18C, the via hole 1322 is filled with the conductive material by the electroless plating ready for high aspect ratio and then by the electrolytic plating ready for high aspect ratio to form a via portion 1323. Then, copper films 1320 are formed over the surfaces.

For example, the via portion 1323 can be formed in the following manner. After the thin film whose thickness ranges from about 0.5 to about 1 μm is formed over the surface by the electroless copper plating, the film having the thickness of about 20 μm is formed by the electrolytic plating. Usually palladium is used as the electroless plating catalyst. In order to cause the electroless plating catalyst to adhere to the flexible dielectric resin, palladium is contained in an aqueous solution while being in the complex state, and the flexible dielectric base material is dipped to cause the palladium complex to adhere to the surface of the dielectric base material. In the state of things, the nuclei for starting the plating onto the surface of the flexible dielectric base material can be formed by reducing the palladium complex to the metal palladium with the reducing agent.

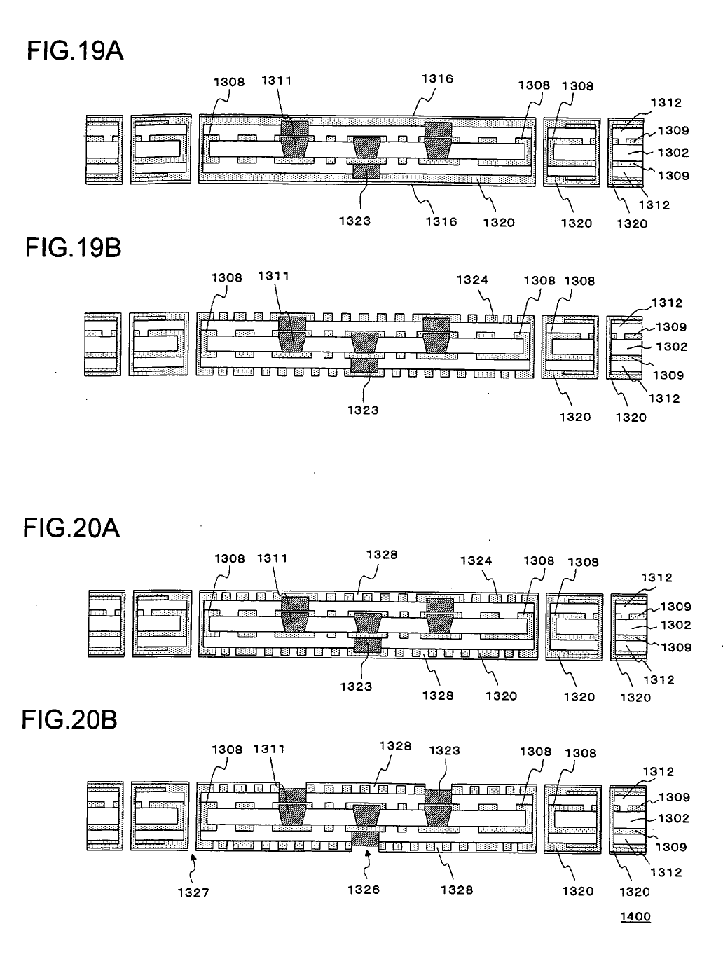

As shown in FIG. 19A, photo-etching resist layers 1316 are laminated onto the top surfaces of the upper and lower copper films 1320. As shown in FIG. 19B, the patterning is performed by the exposure with glass as the mask, and wiring 1324 made of copper is formed by etching the copper film 1320 using the photo-etching resist layer 1316 as the mask. For example, the wiring pattern can be formed by spraying the point exposed from the resist with the chemical etching solution to remove the unnecessary copper foil.

As shown in FIG. 20A, the photoimageable solder resist layers 1328 are laminated onto the top surfaces of the upper wiring 1324 and the lower wiring 1324. For example, the thickness of the photoimageable solder resist layer 1328 is set to e.g. about 25 μm. With reference to the laminating conditions, for example, the temperature is set to 110° C., the time is set in the range from 1 to 2 minutes, and the pressure is set to about 2 atmospheres. Then, the photoimageable solder resist layer 1328 is partially cured by the after-baking process.

For example, it is possible that the cardo type polymer contained resin film and the like are used as the photoimageable solder resist layer 1328.

As shown in FIG. 20B, after the patterning is performed by the exposure with the glass as the mask, the via hole 1326 having the diameter of about 100 nm is formed by the chemical etching process using chemicals so that the via portion 1323 formed inside the via hole 1322 is exposed. In Example, 1, for example, the chemical etching process using chemicals is used for the method of forming the via hole 1326. Then, gold plating is performed on the exposed via portion 323 (not shown).

The effect that the cardo type polymer contained resin film is used for the base material 1302, the dielectric resin film 1312, and the photoimageable solder resist layer 1328 in Example 1 will be described below.

The cardo type polymer is a general term for the polymer having the structure in which a cyclic group is directly bonded to the polymer main chain as shown in Chemical Formula III. Where R₁ and R₂ express the bivalent groups such as the alkylene group and the group containing the aromatic ring.
[Chemical Formula III]

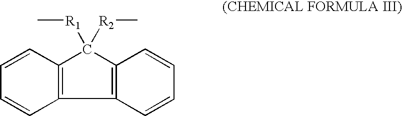

Namely, the cardo type polymer shall mean the polymer having the structure in which the bulky substituent group containing the quaternary carbon atom is substantially perpendicular to the main chain.

It is possible that cyclic portion includes either the saturated bond or the unsaturated bond. In addition to the carbon atom, it is possible that cyclic portion includes atoms such as the nitrogen atom, the oxygen atom, the sulfur atom, and the phosphorus atom. It is possible that the cyclic portion is formed in the polycycle or the fused ring. It is possible that the cyclic portion is bonded to other carbon chains. Further, it is possible that the cross-linkage is formed on the cyclic portion.

As shown in Chemical Formula III, the cyclic group such as the fluorenyl group which includes the fused ring having the structure, in which the six-membered rings are bonded to both sides of the five-membered ring and the remaining one carbon atom of the five-membered ring is bonded to the main chain, can be cited as an example of the bulky substituent group.

As shown in Chemical Formula IV, the fluorenyl group is one in which the 9-position carbon atom of fluolene is dehydrogenized. In the cardo type polymer, as shown in Chemical Formula I, the fluorenyl group is bonded to the carbon atom of the alkyl group which is of the main chain at the position of the dehydrogenized carbon atom.
[Chemical Formula IV]

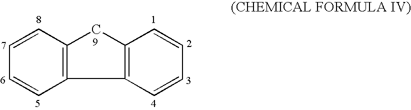

Since the cardo type polymer is one which has the above structure, the cardo type polymer has the following effects:
(1) Rotation constraint of polymer main chain.
(2) Conformation control of main chain and side chain.
(3) Packing obstruction between molecules.
(4) Increase in aromaticity by introducing aromatic substituent group to side chain.

Accordingly, the cardo type polymer has the advantages such as the high mechanical strength, high heat-resistant properties, solvent solubility, high transparency, high refractive index, low birefringence, and higher gas permeability.

The cardo type polymer contained resin film used for the base material 1302 can be formed into the thin film while the voids and the unevenness are suppressed to occur by using a predetermined additive. Therefore, the film having the thickness of about 40 μm can be used as the base material 1302. The thickness of the film becomes about two-thirds, when compared with the conventional resin material having the thickness of about 60 μm, which is used for the base material. Further, the cardo type polymer contained resin film has the excellent adhesion properties and heat-resistant properties as described later. Accordingly, the device mounting board 1400 of Example 1 can be miniaturized while the reliability is improved by using the cardo type polymer contained resin film as the base material 1302.

In addition to the base material 1302, it is also possible that the cardo type polymer contained resin film is used for the photoimageable solder resist layer 1328. This allows the following effects to be further obtained.

The cardo type polymer contained resin film used for the photoimageable solder resist layer 1328 can be formed into the thin film while the voids and the unevenness are suppressed to occur by using the predetermined additive. Therefore, the film having the thickness of about 25 μm can be used as the photoimageable solder resist layer 1328. The thickness of the film becomes about two-thirds, when compared with the conventional resin material having the thickness of about 35 μm, which is used for the photoimageable solder resist layer. Accordingly, the device mounting board 1400 can further be miniaturized. Further, the cardo type polymer contained resin film is excellent in the humidity resistance properties and the resolution properties. Therefore, the reliability can further be improved in the device mounting board 1400 by using the cardo type polymer contained resin film as the photoimageable solder resist layer 1328 in addition to the base material 1302. When compared with the spin coating method which has room for the improvement in that the voids are easily produced in outer periphery of the photoimageable solder resist layer or the potting method which has room for the improvement in that the voids are easily produced after application because an adhesive is in a liquid state before bonding, since the voids and the unevenness are suppressed to occur during the compression-bonding of the film, the voids and the unevenness are hardly generated in the dielectric resin film 1312 of the device mounting board 1400 to which the film is compression-bonded. Therefore, the reliability and production stability of the device mounting board 1400 can further be improved.

The cardo type polymer contained resin film used for the dielectric resin film 1312 can be formed into the thin film while the voids and the unevenness are suppressed to occur by using the predetermined addition agent. Therefore, the film having the thickness of about 25 μm can be used as the dielectric resin film 1312. The thickness of the film becomes about two-thirds, when compared with the conventional resin material having the thickness of about 40 μm, which is used for the dielectric resin film. Accordingly, the device mounting board 1400 can be miniaturized by using the cardo type polymer contained resin film as the dielectric resin film 1312. Further, the cardo type polymer contained resin film is excellent in the adhesion properties, dielectric characteristics, and the heat-resistant properties as described later, so that the dielectric resin film 1312 is excellent in the interlayer adhesion properties, the parasitic capacitance is decreased in the dielectric resin film 1312, and the dielectric resin film 1312 is excellent in the heat-resistant properties. Since the voids and the unevenness are suppressed to occur during the compression-bonding of the film, the voids and the unevenness are hardly produced in the dielectric resin film 1312 of the device mounting board 1400 to which the film is compression-bonded. Therefore, the reliability and production stability of the device mounting board 1400 can be improved.

In addition to the dielectric resin film 1312, it is also possible that the cardo type polymer contained resin film is used for the photoimageable solder resist layer 1328. This allows the following effects to be further obtained.

The cardo type polymer contained resin film used for the photoimageable solder resist layer 1328 can be formed into the thin film while the voids and the unevenness are suppressed to occur by using the predetermined additive. Therefore, the film having the thickness of about 25 μm can be used as the photoimageable solder resist layer 1328. The thickness of the film becomes about two-thirds, when compared with the conventional resin material having the thickness of about 35 μm, which is used for the photoimageable solder resist layer. Accordingly, the device mounting board 1400 can further be miniaturized. Further, the cardo type polymer contained resin film is excellent in the adhesion properties, the moisture resistance properties, the dielectric characteristics, and the resolution properties. Therefore, the adhesion properties between the photoimageable solder resist layer 1328 and the device mounted on the photoimageable solder resist layer 1328 can be improved, the dimensional accuracy can be also improved in making the via hole in the photoimageable solder resist layer 1328, and the parasitic capacitance can be decreased. Accordingly, the reliability can further be improved in the device mounting board 1400 by using the cardo type polymer contained resin film as the photoimageable solder resist layer 1328 in addition to the dielectric resin film 1312. When compared with the spin coating method which has room for the improvement in that the voids are easily produced in outer periphery of the photoimageable solder resist layer or the potting method which has room for the improvement in that the voids are easily produced after application because an adhesive is in a liquid state before bonding, since the voids and the unevenness are suppressed to occur during the compression-bonding of the film, the voids and the unevenness are hardly produced in the photoimageable solder resist layer 1328 of the device mounting board 1400 to which the film is compression-bonded. Therefore, the reliability and production stability of the device mounting board 1400 can further be improved.

It is possible that the cardo type polymer contained resin film is used for both the base material 1302 and the dielectric resin film 1312. Therefore, the cardo type polymer contained resin film is excellent in the characteristics such as the heat-resistant properties, the adhesion properties, the moisture resistance properties, the dielectric characteristics, and the resolution properties, and the cardo type polymer contained resin film can be formed into the thin film, so that the reliability and production stability of the device mounting board 1400 can remarkably be improved, and the further miniaturization can be realized.

It is possible that the cardo type polymer contained resin film is used for all of the base material 1302, the dielectric resin film 1312, and the photoimageable solder resist layer 1328. Therefore, the cardo type polymer contained resin film is excellent in the characteristics such as the heat-resistant properties, the adhesion properties, the moisture resistance properties, the dielectric characteristics, and the resolution properties as described later, and the cardo type polymer contained resin film can be formed into the thin film, so that the reliability and production stability of the device mounting board 1400 can remarkably be improved, and the further miniaturization can be realized.

It is also possible that the cardo type polymer is one which is formed of the cross-linked polymer having the carboxyl group and the acrylate group in the same molecular chain. Conventionally, the blend of the carboxyl group oligomer having development properties and a polyfunctional acryl is used as the general photosensitive varnish. However, the general photosensitive varnish still has room for improvement in the resolution. When the cardo type polymer formed of the cross-linked polymer having the carboxyl group and the acrylate group in the same molecular chain is used instead of the general photosensitive varnish, the cardo type polymer has the carboxyl group having the development properties and the acrylate group which is of the cross-linking group in the same molecular chain, and the cardo type polymer also has the bulky substituent group in the main chain, so that the radical diffusion is difficult to occur. Therefore, in the cardo type polymer contained photoimageable solder resist film, there is the advantage that the resolution is improved.

It is desirable that the cardo type polymer contained resin film satisfies the following physical properties. The following physical properties are the value for the resin portion which does not include the filler and the like, and the physical properties can be appropriately adjusted by adding the filler and the like.

In the cardo type polymer contained resin film, it is preferable that the glass transition temperature (Tg) is not lower than 180° C., and it is more preferable that Tg is e.g. not lower than 190° C. When Tg exists in the above range, the heat-resistant properties are improved in the cardo type polymer contained resin film.

In the cardo type polymer contained resin film, it is preferable that Tg is e.g. not more than 220° C., it is more preferable that Tg is not more than 210° C. When Tg exists in the above range, the cardo type polymer contained resin film can stably be produced by the usual manufacturing method. Tg can be measured by the dynamic viscoelasticity measurement (DMA).

In the range of not more than Tg of the cardo type polymer contained resin film, it is preferable that the linear expansion coefficient (CTE) of the cardo type polymer contained resin film is e.g. not more than 80 ppm/° C., and it is more preferable that CTE is not more than 75 ppm/° C. When CTE exists in the above range, the adhesion properties between the cardo type polymer contained resin film and other members are improved.

In the range of not more than Tg of the cardo type polymer contained resin film, it is preferable that CTE of the cardo type polymer contained resin film is not lower than 50 ppm/° C., and it is more preferable that CTE is not lower than 55 ppm/° C. Further, the resin composition having CTE of not more than 20 ppm/° C. can be obtained by mixing the filler in the cardo type polymer contained resin film. When CTE exists in the above range, the cardo type polymer contained resin film can stably be produced by the usual manufacturing method. CTE can be measured according to the thermal expression measurement by the thermo-mechanical analysis apparatus (TMA).

It is preferable that heat conductivity of the cardo type polymer contained resin film is e.g. not more than 0.50 W/cm²·sec, and it is more preferable that the heat conductivity is not more than 0.35 W/cm²·sec. When the heat conductivity exists in the above range, the heat-resistant properties are improved in the cardo type polymer contained resin film.

It is preferable that the heat conductivity of the cardo type polymer contained resin film is e.g. not lower than 0.10 W/cm²·sec, and it is more preferable that the heat conductivity is not lower than 0.25 W/cm²·sec. When the heat conductivity exists in the above range, the cardo type polymer contained resin film can stably be produced by the usual manufacturing method. For example, the heat conductivity can be measured by the disk heat flow meter method (ASTM E1530).

In the via portion which has the diameter ranging from 10 to 100 μm in the cardo type polymer contained resin film, it is preferable that the via aspect ratio is e.g. not lower than 0.5, and it is more preferable that the via aspect ratio is not lower than 1. When the via aspect ratio exists in the above range, the resolution is improved in the cardo type polymer contained resin film.

In the via portion which has the diameter ranging from 10 to 100 μm in the cardo type polymer contained resin film, it is preferable that the via aspect ratio is e.g. not more than 5, and it is more preferable that the via aspect ratio is not more than 2. When the via aspect ratio exists in the above range, the cardo type polymer contained resin film can stably be produced by the conventional manufacturing method.

In the case where an alternating electric field having the frequency of 1 MHz is applied to the cardo type polymer contained resin film, it is preferable that the dielectric constant of the cardo type polymer contained resin film is e.g. not more than 4, and it is more preferable that the dielectric constant is not more than 3. When the dielectric constant exists in the above range, the dielectric characteristics such as the high-frequency characteristics are improved in the cardo type polymer contained resin film.

In the case where the alternating electric field having the frequency of 1 MHz is applied to the cardo type polymer contained resin film, it is possible that the dielectric constant of the cardo type polymer contained resin film is e.g. not lower than 0.1, and it is more preferable that the dielectric constant is not lower than 2.7. When the dielectric constant exists in the above range, the cardo type polymer contained resin film can stably be produced by the conventional manufacturing method.

In the case where the alternating electric field having the frequency of 1 MHz is applied to the cardo type polymer contained resin film, it is preferable that the dielectric dissipation factor of the cardo type polymer contained resin film is e.g. not more than 0.04, and it is more preferable that the dielectric dissipation factor is not more than 0.029. When the dielectric dissipation factor exists in the above range, the dielectric characteristics such as the high-frequency characteristics are improved in the cardo type polymer contained resin film.

In the case where the alternating electric field having the frequency of 1 MHz is applied to the cardo type polymer contained resin film, it is preferable that the dielectric dissipation factor of the cardo type polymer contained resin film is e.g. not lower than 0.001, and it is more preferable that the dielectric dissipation factor is not lower than 0.027. When the dielectric dissipation factor exists in the above range, the cardo type polymer contained resin film can stably be produced by the conventional manufacturing method.

In the cardo type polymer contained resin film, it is preferable that the 24-hour water absorption (wt %) is e.g. not more than 3 wt %, and it is more preferable that the 24-hour water absorption (wt %) is not more than 1.5 wt %. When the 24-hour water absorption exists in the above range, the moisture resistance is improved in the cardo type polymer contained resin film.

In the cardo type polymer contained resin film, it is preferable that the 24-hour water absorption (wt %) is e.g. not lower than 0.5 wt %, and it is more preferable that the 24-hour water absorption is not lower than 1.3 wt %. When the 24-hour water absorption (wt %) exists in the above range, the cardo type polymer contained resin film can stably be produced by the conventional manufacturing method.

The characteristics such as the thinning of film, the mechanical strength, the heat-resistant properties, the adhesion properties to other members, the dielectric characteristics, and the moisture resistance are required for the base material 1302 for which the cardo type polymer contained resin film is used. The characteristics required for the base material 1302 are realized in a well-balanced manner, when the cardo type polymer contained resin film satisfies the above-mentioned physical properties.

The characteristics such as the thinning of film, the mechanical strength, the heat-resistant properties, the adhesion properties to other members, the dielectric characteristics, and the moisture resistance are required for the dielectric resin film 1312 for which the cardo type polymer contained resin film is used. The characteristics required for the dielectric resin film 1312 are realized in a well-balanced manner, when the cardo type polymer contained resin film satisfies the above-mentioned physical properties.

The characteristics such as the thinning of film, the mechanical strength, the heat-resistant properties, the adhesion properties to other members, the resolution, the dielectric characteristics, and the moisture resistance are required for the photoimageable solder resist layer 1328 for which the cardo type polymer contained resin film is used. The characteristics required for the photoimageable solder resist layer 1328 are realized in a well-balanced manner, when the cardo type polymer contained resin film satisfies the above-mentioned physical properties.

### EXAMPLE 2

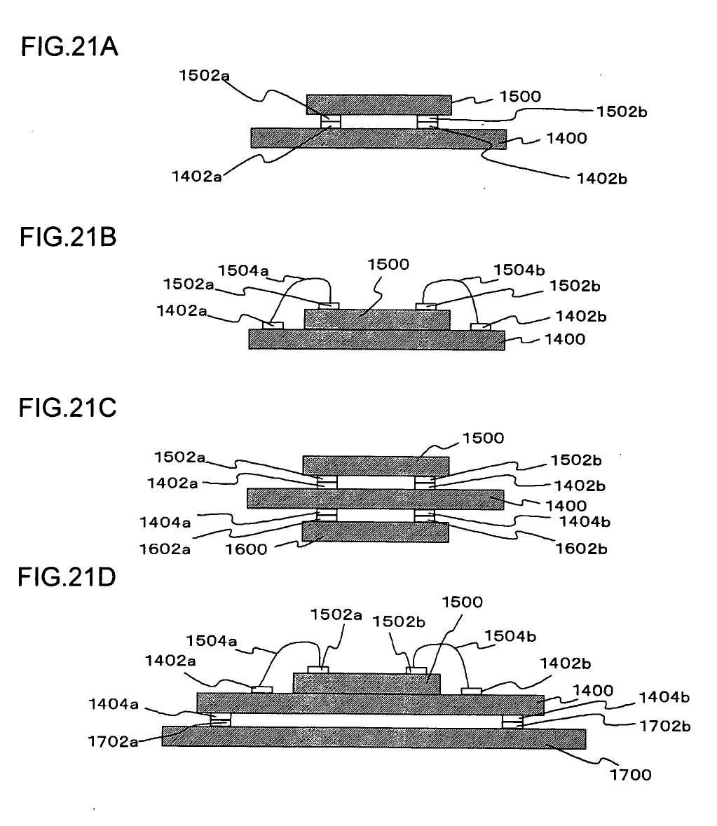

FIGS. 21A to 21D are a sectional view schematically showing various methods of mounting the semiconductor device on the device mounting board 1400 including the four-layer ISB structure according to Example 2.

In Example 2, the cardo type polymer contained resin film is equal to the cardo type polymer contained resin film described in Example 1.

There are various modes in the semiconductor apparatus which is formed by mounting the semiconductor device on the device mounting board 1400 described in Example 2. For example, there is the mode in which the semiconductor device is mounted on the device mounting board 1400 by the flip chip connection or the wire bonding connection. There is the mode the semiconductor device is mounted on the device mounting board 1400 by taking the face up structure or the face down structure. There is the mode in which the semiconductor device is mounted on one side or both sides of the device mounting board 1400. Further, there is the mode in which these various modes are combined.

Specifically, as shown in FIG. 21A, a semiconductor device 1500 such as LSI can be mounted on the device mounting board 1400 of Example 1 in the flip chip form. At this point, electrode pads 1402a and 1402b on the upper surface of the device mounting board 1400 are directly connected to electrode pads 1502a and 1502b of the semiconductor device 1500 respectively.

As shown in FIG. 21B, the semiconductor device 1500 such as LSI can be mounted on the device mounting board 1400 by taking the face up structure. At this point, the electrode pads 1402a and 1402b located on the top of the device mounting board 1400 are connected to the electrode pads 1502a and 1502b located on the top of the semiconductor device 1500 through gold wires 1504a and 1504b by the wire bonding connection respectively.

As shown in FIG. 21C, the semiconductor device 1500 such as LSI can be mounted on the device mounting board 1400 in the flip chip form, and a semiconductor device 1600 such as IC can be mounted beneath the device mounting board 1400 in the flip chip form. At this point, the electrode pads 1402a and 1402b located on the top of the device mounting board 1400 are directly connected to the electrode pads 1502a and 1502b of the semiconductor device 1500 respectively. Further, the electrode pads 1402a and 1402b located on the lower surface of the device mounting board 1400 are directly connected to electrode pads 1602a and 1602b of the semiconductor device 1600 respectively.

As shown in FIG. 21D, the semiconductor device 1500 such as LSI can be mounted on the device mounting board 1400 by taking the face up structure, and the device mounting board 1400 can be mounted on a printed board 1700. At this point, the electrode pads 1402a and 1402b located on the top of the device mounting board 1400 are connected to the electrode pads 1502a and 1502b located on the top of the semiconductor device 1500 by wire bonding connection respectively. Further, the electrode pads 1404a and 1404b located on the lower surface of the device mounting board 1400 are directly connected to electrode pads 1702a and 1702b located on the top of the printed board 1700 respectively.

As described in Example 1, the device mounting board 1400 in which the cardo type polymer contained resin film is used as the base material 1302 is used in the semiconductor apparatus having any structure described above. Therefore, the device mounting board 1400 is excellent in the characteristics such as the heat-resistant properties and the rigidity, the device mounting board 1400 has the high reliability, and the device mounting board 1400 is miniaturized. Accordingly, mounting the semiconductor device on the device mounting board 1400 can provide the miniaturized semiconductor apparatus having the high reliability.

It is also possible that the semiconductor device is mounted on the device mounting board 1400 in which the cardo type polymer contained resin film is used for the photoimageable solder resist layer 1328 in addition to the base material 1302. This allows the following effects to be further obtained.

The cardo type polymer contained resin film can be used as the photoimageable solder resist layer 1328. Since the cardo type polymer contained resin film has the features described in Example 1, the photoimageable solder resist layer 1328 is excellent in the characteristics such as the heat-resistant properties, the rigidity, and the adhesion properties to a device. The photoimageable solder resist layer 1328 is also excellent in the resolution, so that the dimensional accuracy is improved in mounting the semiconductor device on the device mounting board 1400 by using the cardo type polymer contained resin film as the photoimageable solder resist layer 1328. Therefore, when the cardo type polymer contained resin film is used as the photoimageable solder resist layer 1328, the reliability can further be improved in the device mounting board 1400, and the device mounting board 1400 can further be miniaturized. As a result, mounting the semiconductor device on the device mounting board 1400 in which the cardo type polymer contained resin film is used for the photoimageable solder resist layer 1328 in addition to the base material 1302 can provide the further miniaturized semiconductor apparatus having the higher reliability.

The device mounting board 1400 in which the cardo type polymer contained resin film is used as the dielectric resin film 1312 is used in Example 2. Therefore, the device mounting board 1400 is excellent in the characteristics such as the heat-resistant properties, the rigidity, and the interlayer adhesion properties, and the parasitic capacitance, the device mounting board 1400 has the high reliability, and the device mounting board 1400 is miniaturized. As a result, mounting the semiconductor device on the device mounting board 1400 in which the cardo type polymer contained resin film is used for the dielectric resin film 1312 can provide the miniaturized semiconductor apparatus having the high reliability.

It is also possible that the semiconductor device is mounted on the device mounting board 1400 in which the cardo type polymer contained resin film is used for the photoimageable solder resist layer 1328 in addition to the dielectric resin film 1312. This allows the following effects to be obtained.

The cardo type polymer contained resin film can be used as the photoimageable solder resist layer 1328. Since the cardo type polymer contained resin film has the features described in Example 1, the photoimageable solder resist layer 1328 is excellent in the characteristics such as the heat-resistant properties, the rigidity, the dielectric characteristics, and the adhesion properties to the device. The photoimageable solder resist layer 1328 is also excellent in the resolution, so that the dimensional accuracy is improved in mounting the semiconductor device on the device mounting board 1400 by using the cardo type polymer contained resin film as the photoimageable solder resist layer 1328. Therefore, when the cardo type polymer contained resin film is used as the photoimageable solder resist layer 1328, the reliability can further be improved in the device mounting board 1400, and the device mounting board 1400 can further be miniaturized. As a result, mounting the semiconductor device on the device mounting board 1400 in which the cardo type polymer contained resin film is used for the photoimageable solder resist layer 1328 in addition to the dielectric resin film 1312 can provide the further miniaturized semiconductor apparatus having the higher reliability.

It is also possible that the semiconductor device is mounted on the device mounting board 1400 in which the cardo type polymer contained resin film is used for both the base material 1302 and the dielectric resin film 1312. The cardo type polymer contained resin film is excellent in the characteristics such as the heat-resistant properties, the mechanical strength, the adhesion properties, the moisture resistance properties, the dielectric characteristics, and the resolution properties, and the cardo type polymer contained resin film can be formed into the thin film, so that the materials constituting the device mounting board 1400 are excellent in aspects of the rigidity, the heat-resistant properties, the interlayer adhesion properties, and the parasitic capacitance. Therefore, the reliability and the production stability can remarkably be improved and the further miniaturization can be realized in the device mounting board 1400. As a result, mounting the semiconductor device on the device mounting board 1400 in which the cardo type polymer contained resin film is used for both the base material 1302 and the dielectric resin film 1312 can provide the semiconductor apparatus in which the reliability and the production stability can remarkably be improved and the further miniaturization can be realized.

It is also possible that the semiconductor device is mounted on the device mounting board 1400 in which the cardo type polymer contained resin film is used for all of the base material 1302, the dielectric resin film 1312, and the photoimageable solder resist layer 1328. The cardo type polymer contained resin film is excellent in the characteristics such as the heat-resistant properties, the mechanical strength, the adhesion properties, the moisture resistance properties, the dielectric characteristics, and the resolution properties, and the cardo type polymer contained resin film can be formed into the thin film, so that the materials constituting the device mounting board 1400 are excellent in aspects of the rigidity, the heat-resistant properties, the interlayer adhesion properties, the parasitic capacitance, the dimensional accuracy in mounting the device, and the flatness. Therefore, the reliability and the production stability can remarkably be improved and the further miniaturization can be realized in the device mounting board 1400. As a result, mounting the semiconductor device on the device mounting board 1400 in which the cardo type polymer contained resin film is used for all of the base material 1302, the dielectric resin film 1312, and the photoimageable solder resist layer 1328 can provide the semiconductor apparatus in which the reliability and the production stability can remarkably be improved and the further miniaturization can be realized.

The third embodiment is not limited to Examples 1 and 2, and it is understood that those skilled in the art could modify the third embodiment without departing from the scope of the invention.

In Example 2, the cardo type polymer contained resin film is used for the base material 1302, the dielectric resin film 1312, and the photoimageable solder resist layer 1328 which compose the device mounting board 1400. However, in the device mounting board except for the device mounting board 1400 having the four-layer ISB structure, it is also possible that the cardo type polymer contained resin film is used for the base material, the dielectric resin film, and the photoimageable solder resist layer.

Although the device mounting board 1400 which has the four-layer ISB structure including the four wiring layers is described in Example 2, it is also possible to use the device mounting board which has the ISB structure including at least four wiring layers, e.g. six wiring layers.

In Example 2, the cardo type polymer contained resin film is used as the photoimageable solder resist layer 1328 constituting the device mounting board 1400. However, it is possible that other materials are used as the photoimageable solder resist layer 1328.

Fourth Embodiment

In an aspect of a fourth embodiment, a device mounting board on which a device is mounted is provided, the device mounting board includes a base material; a dielectric film which is provided on the base material; and a solder resist layer which is provided on the dielectric film, the solder resist layer having a plurality of layers, wherein at least one of the layers in the solder resist layer contains a cardo type polymer.

According to the fourth embodiment, at least one of the layers in the solder resist layer contains the cardo type polymer, and the cardo type polymer is excellent in the characteristics such as the adhesion properties and the moisture absorption properties, so that the device mounting board having the high reliability can be provided.

It is also possible that a top surface layer of the solder resist layer contains the cardo type polymer.

It is also possible that the wiring for connecting the device is provided in the solder resist layer.

It is possible that the glass transition temperature of the solder resist layer containing the cardo type polymer ranges from 180° C. to 220° C. In the case where the alternating electric field having the frequency of 1 MHz is applied to the solder resist layer containing the cardo type polymer, it is possible that the dielectric dissipation factor of the solder resist layer containing the cardo type polymer ranges from 0.001 to 0.04.

In the range not more than the glass transition temperature of the solder resist layer containing the cardo type polymer, it is possible that the linear expansion coefficient of the solder resist layer containing the cardo type polymer ranges from 50 ppm/° C. to 80 ppm/° C.

In another aspect of the fourth embodiment, a semiconductor apparatus includes any one of the above device mounting boards and a semiconductor device which is mounted on the device mounting board.

According to the fourth embodiment, the semiconductor apparatus having the high reliability can be provided by including the device mounting board having the high reliability.

It is possible that the dielectric film is formed of either the single-layer dielectric film or the multi-layer dielectric film.

In the fourth embodiment, the device mounting board shall mean the board on which the semiconductor device such as the LSI chip and the IC chip is mounted. The interposer board in the later-described ISB (registered trademark) structure can be cited as an example of the device mounting board. It is possible that the device mounting board includes the core board such as a silicon substrate having the rigidity, or it is possible that the device mounting board does not includes the core board but has the core-less structure including the multi-layer dielectric film formed of the dielectric resin films.

### EXAMPLE 3

FIG. 29B is a sectional view showing the device mounting board 2400 including the four-layer ISB structure according to Example 3.

The device mounting board 2400 according to Example 3 has the structure in which an dielectric resin film 2312 and a photoimageable solder resist layer 2328 are sequentially laminated on the upper surface of a base material 2302. The device mounting board 2400 also has the structure in which the dielectric resin film 2312 and the photoimageable solder resist layer 2328 are sequentially laminated on the lower surface of the base material 2302. Further, the photoimageable solder resist layer 2328 has the structure in which a resin layer 2328b and a resin layer 2328a are laminated in the order in which they are close to the dielectric resin film 2312.

The four-layer ISB structure shall mean the structure which has the four wiring layers. The wiring layers are embedded in the dielectric resin film 2312 and the photoimageable solder resist layer 2328. For convenience of the process of making the via hole in the photoimageable solder resist layer 2328, it is necessary that the photoimageable solder resist layer 2328 has photosensitivity.

In the four-layer ISB structure, the same materials forming the upper and lower surfaces of the dielectric resin layers 2312 can be used while sandwiching the base material 2302. Further, the same materials forming the upper and lower surfaces of the photoimageable solder resist layers 2328 can be used while sandwiching the base material 2302. Therefore, from the viewpoint of process, there is the advantage that the manufacturing process can be simplified.

A through-hole 2327 which pierces through the base material 2302, the dielectric resin film 2312, and the photoimageable solder resist layer 2328 is made.

A part of the piece of wiring made of a copper film 2308, a part of the piece of wiring made of a copper film 2320, a part of a via portion 2311, and the like are embedded in the base material 2302. A part of the piece of the wiring made of the copper film 2308, a part of the piece of the wiring made of the copper film 2320, wiring 2309, a part of the via portion 2311, a part of a via portion 2323, and the like are embedded in the dielectric resin film 2312. A part of the piece of the wiring made of the copper film 2320, a part of the via portion 2323, and the like are embedded in the photoimageable solder resist layer 2328. An opening 2326 is provided in the photoimageable solder resist layer 2328.

The material used for the base material 2302 is not limited to the glass epoxy board, and any material having the moderate rigidity can be used as the base material 2302. For example, the resin board and the ceramic board can be used as the base material 2302. More specifically, the base material which is excellent in the high-frequency characteristics because of the low dielectric constant can be used. Namely, examples of the base material 2302 include polyphenyl ethylene (PPE), bismaleimide triazine resins (BT-resin), polytetrafluoro-ethylene (Teflon; registered trademark), polyimide, liquid crystal polymer (LCP), polynorbornene (PNB), epoxy resins, acrylic resins, ceramics, the mixture of ceramic and the organic base material. For example, the thickness of the base material 2302 is set to about 60 μm.

The resin material used for the dielectric resin film 2312 is one which is softened by the heating, and the resin material which can thin the dielectric resin film 2312 to a certain level is used. Particularly the resin material which is excellent in the high-frequency characteristics because of the low dielectric constant can preferably be used. At this point, the thickness of the dielectric resin film is set to e.g. about 40 μm.

It is possible that the dielectric resin film 2312 contains the filling material such as the filler or the fiber. For example, the granular or fibrous SiO₂ or silicon nitride can be used as the filler.

The cardo type polymer contained resin film later-described is used as the resin layer 2328a constituting the photoimageable solder resist layer 2328. It is preferable that the resins such as polyimide and epoxy having photosensitivity are used as the resin material constituting the resin layer 2328b, and it is more preferable to use the thermosetting and photosensitive resins such as epoxy which is equal to the resin material constituting the resin layer 2328a. It is preferable that the thickness of the resin layer 2328b is e.g. about 35 μm, and it is more preferable that the thickness of the resin layer 2328a is e.g. about 25 μm.

In the cardo type polymer, the bulky substituent group obstructs movement of the main chain, which results in the excellent mechanical strength, excellent heat-resistant properties, and the low linear expansion coefficient. Therefore, in the heat cycle, the decrease in adhesion properties and the delamination are suppressed between the resin layer 2328a and the layer around the resin layer 2328a by using the cardo type polymer contained resin film as the resin layer 2328a. As a result, the reliability and the heat-resistant properties are improved in the device mounting board 2400 according to Example 3.

The multilayer wiring structure including the wiring formed of copper film 2308, the wiring formed of the copper film 2320, the wiring 2309, the via portion 2311, and the via portion 2323 is not limited to the copper wiring. For example, the aluminum wiring, the aluminum alloy wiring, the copper alloy wiring, the wire-bonded gold wiring, the gold alloy wiring, the mixed wiring formed by these pieces of wiring, and the like can also be used as the multilayer wiring structure.

It is also possible that the active elements such as the transistor and the diode and passive elements such as the capacitor and the resistor are provided on the surface of or in the four-layer ISB structure. It is also possible that the active elements or the passive elements are connected to a multilayer wiring structure in the four-layer ISB and connected to the external conductive member through the via portion 2323.

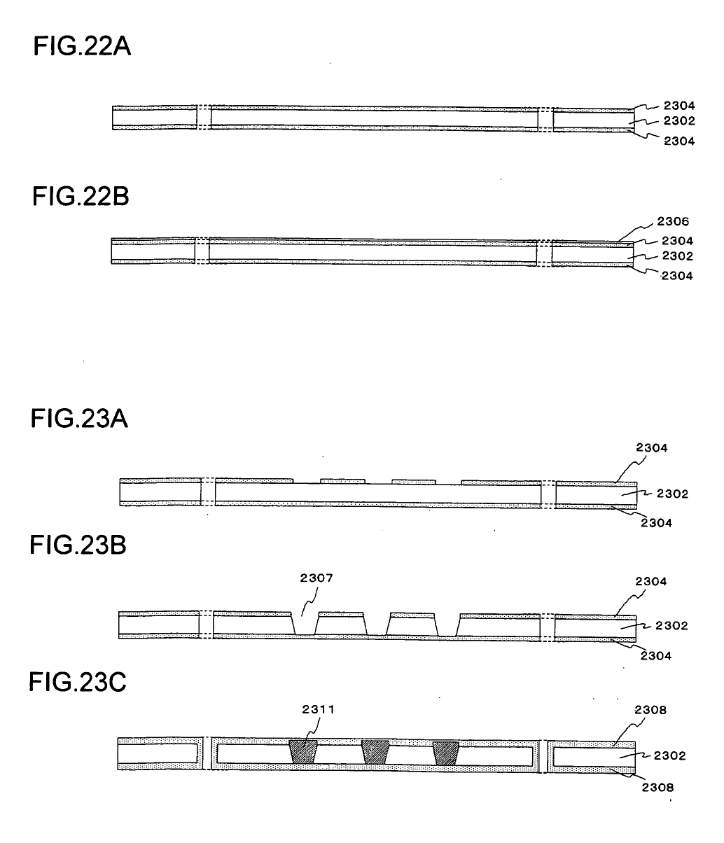

FIGS. 22A to 29B are a process sectional view showing the device mounting board 2400 having the four-layer ISB structure according to Example 3.

As shown in FIG. 22A, the base material 2302 is prepared. The copper foils 2304 are compression-bonded to the base material 2302. Holes having diameters of about 150 nm are made in the copper foil 2304 by the drilling. For example, the thickness of the base material 2302 is set to e.g. about 60 μm, and the thickness of the copper foil 2304 ranges from about 10 μm to about 15 μm.

The resin materials such as epoxy resin, BT-resin, liquid crystal polymer are preferably used as the base material 2302.

As shown in FIG. 22B, a photo-etching resist layer 2306 is laminated on the upper surface of the copper foil 2304.

Then, the patterning of the photo-etching resist layer 2306 is performed by the exposure with glass as the mask. As shown in FIGS. 23A and 23B, a via hole 2307 having the diameter of e.g. about 100 nm is made using the photo-etching resist layer 2306 as the mask. The via hole 2307 is made by the chemical etching process using chemicals. Then, the inside of the via hole 2307 is roughened and cleaned by the wet process. As shown in FIG. 23C, the via hole 2307 is filled with the conductive material to form the via portion 2311 by the electroless plating ready for high aspect ratio and then by the electrolytic plating ready for high aspect ratio. Then, the copper films 2308 are formed over the surfaces.

For example, the via portion 2311 can be formed in the following manner. After the thin film whose thickness ranges from about 0.5 to about 1 μm is formed over the surface by the electroless copper plating, the film having the thickness of about 20 μm is formed by the plating. Usually palladium is used as the electroless plating catalyst. In order to cause the electroless plating catalyst to adhere to the flexible dielectric resin, palladium is contained in the aqueous solution while being in the complex state, and the flexible dielectric base material is dipped to cause the palladium complex to adhere to the surface of the dielectric base material. In the state of things, nuclei for starting the plating onto the surface of the flexible dielectric base material can be formed by reducing the palladium complex to the metal palladium with the reducing agent.

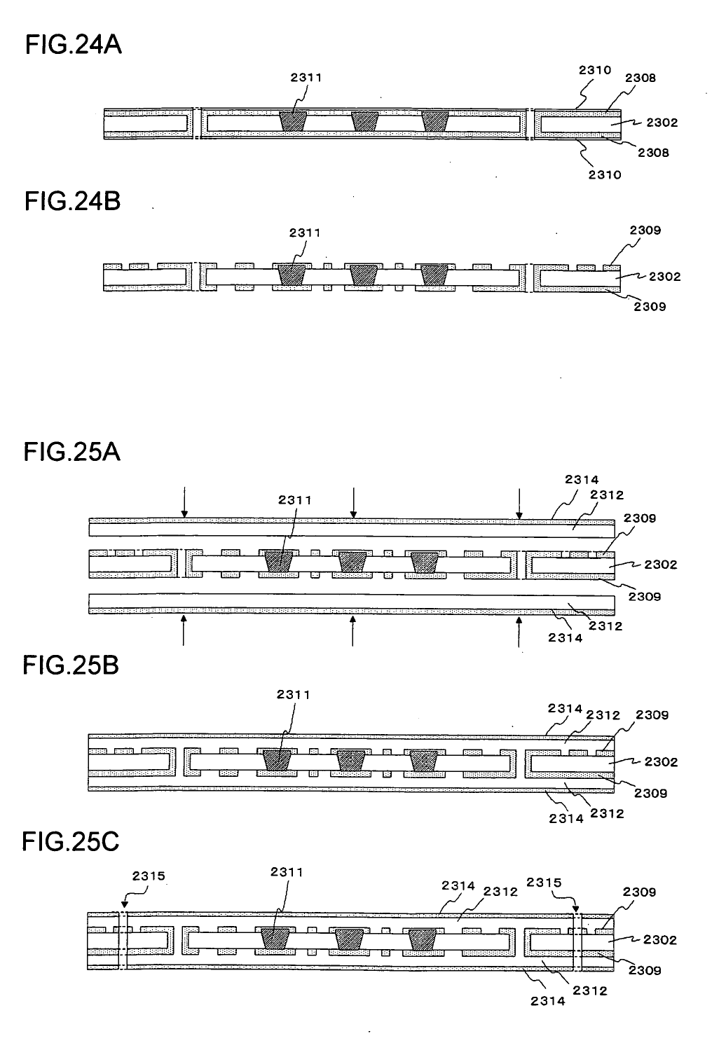

As shown in FIG. 24A, photo-etching resist layers 2310 are laminated onto the top surfaces of the upper and lower copper films 2308. As shown in FIG. 24B, after the patterning is performed on the photo-etching resist layer 2310 by the exposure with glass as the mask, the wiring 2309 made of copper is formed by etching the copper film 2308 using the photo-etching resist layer 2310 as the mask. For example, the wiring pattern can be formed by spraying a point exposed from the resist with the chemical etching solution to remove the unnecessary copper plating.

As shown in FIG. 25A, the dielectric resin films 2312 with copper foils 2314 are compression-bonded to the top surfaces of the upper wiring 2309 and the lower wiring 2309. For example, the thickness of the dielectric resin film 2312 is set to e.g. about 40 μm, and the thickness of the copper foil 2314 is set in the range from e.g. about 10 μm to about 15 μm.

Examples of the material used for the dielectric resin film 2312 include thermosetting resins such as epoxy resin, liquid crystal polymer, PPE resin, polyimide resin, fluororesin, phenolic resin, polyamide bismaleimide, and melamine derivatives such as BT resin. The liquid crystal polymer, epoxy resin, and melamine derivatives such as BT resin which are excellent in the high-frequency characteristics are preferably used as the dielectric resin film 2312. It is possible that the filling material such as the filler and the additive is appropriately added in conjunction with the resin. For example, the granular or fibrous SiO₂ or SiN can be used as the filler.

With reference to the compression-bonding method, the dielectric resin film 2312 with copper foil is caused to come into contact with the base material 2302 and the wiring 2309, and the base material 2302 and the wiring 2309 are fitted into the dielectric resin film 2312. Then, as shown in FIG. 25B, the dielectric resin film 2312 is heated in the vacuum or under the reduced pressure to compression-bond the dielectric resin film 2312 to the base material 2302 and the wiring 2309. As shown in FIG. 25C, the copper foil 2314 is irradiated with the X-ray to make holes 2315 which pierce through the copper foil 2314, the dielectric resin film 2312, the wiring 2309, and the base material 2302.

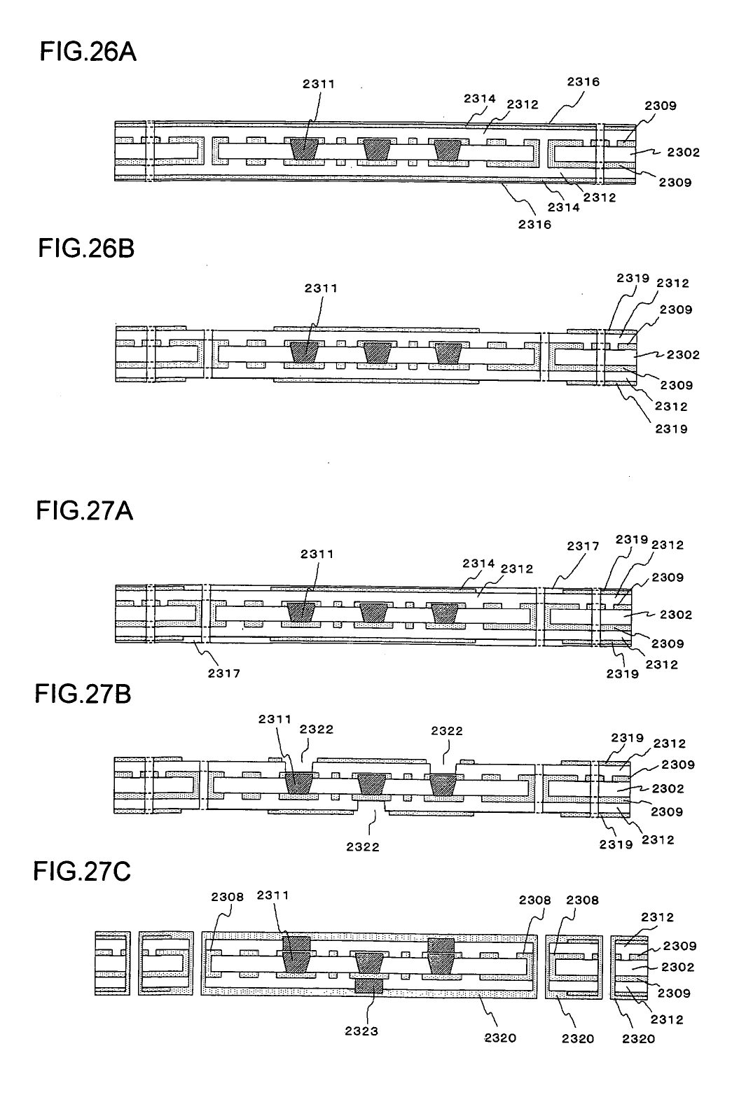

As shown in FIG. 26A, photo-etching resist layers 2316 are laminated on the top surfaces of the upper and lower copper foils 2314. As shown in FIG. 26B, after the patterning of the photo-etching resist layer 2316 is performed by the exposure with the glass as the mask, wiring 2319 made of copper is formed by etching the copper foil 2314 with the photo-etching resist layer 2316 as the mask. For example, the wiring pattern can be formed by spraying a point exposed from the resist with the chemical etching solution to remove the unnecessary copper foil.

As shown in FIG. 27A, a photo-etching resist layer 2317 is laminated onto the surfaces of the upper wiring 2319 and the lower wiring 2319. As shown in FIG. 27B, after the patterning of the photo-etching resist layer 2317 is performed by the exposure with the glass as the mask, via holes 322 having the diameters of about 100 nm are made using the photo-etching resist layer 2317 as the mask. In Example 3, the chemical etching process using the chemicals is adopted as the method of making the via holes 2322. However, machining, dry etching with plasma, laser machining, and the like can also be used for making the via holes 2322. Then, the inside of the via hole 2322 is roughened and cleaned by the wet process. As shown in FIG. 27C, the via hole 2322 is filled with the conductive material to form the via portion 2323 by the electroless plating ready for high aspect ratio and then by the electrolytic plating ready for the high aspect ratio. Then, the copper films 2320 are formed over the surfaces.

For example, the via portion 2323 can be formed in the following manner. After the thin film whose thickness ranges from about 0.5 to about 1 μm is formed over the surface by the electroless copper plating, the film having the thickness of about 20 μm is formed by the electrolytic plating. Usually palladium is used as the electroless plating catalyst. In order to cause the electroless plating catalyst to adhere to the flexible dielectric resin, palladium is contained in the aqueous solution while being in the complex state, and the flexible dielectric base material is dipped to cause the palladium complex to adhere to the surface of the dielectric base material. In the state of things, the nuclei for starting the plating onto the surface of the flexible dielectric base material can be formed by reducing the palladium complex to the metal palladium with the reducing agent.

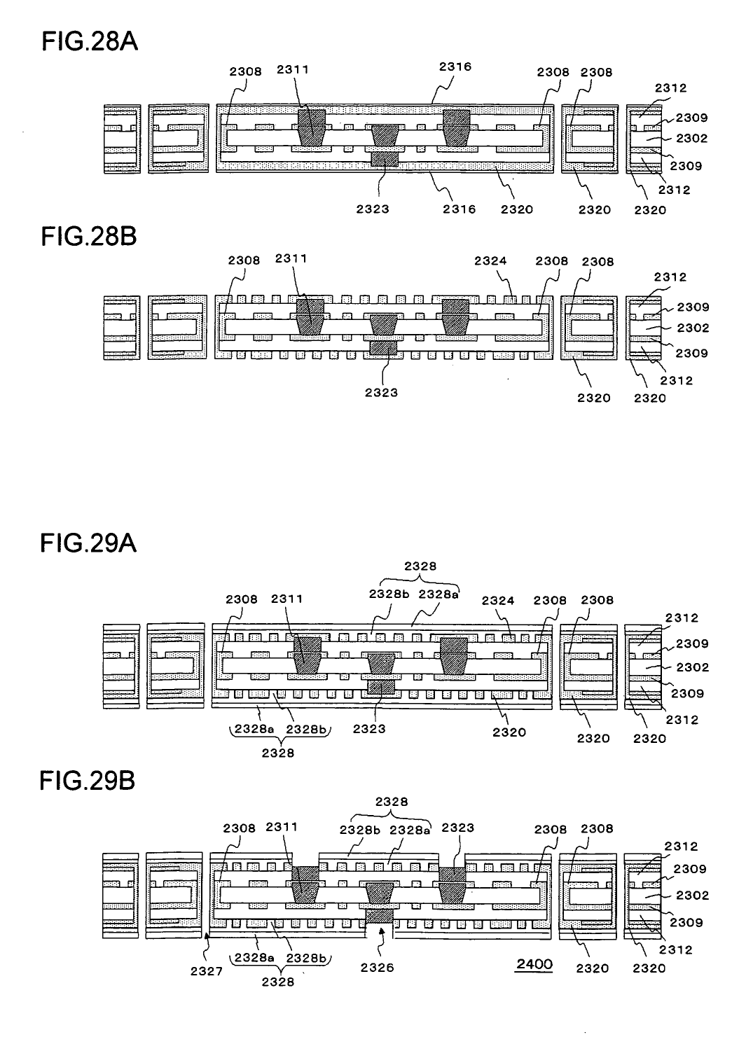

Then, as shown in FIG. 28A, the photo-etching resist layers 2316 are laminated onto the top surfaces of the upper and lower copper films 2320. As shown in FIG. 28B, after the patterning is performed on the photo-etching resist layer 2316 by the exposure with glass as the mask, wiring 2324 made of copper is formed by etching the copper film 2320 using the photo-etching resist layer 2318 as the mask. For example, the wiring pattern can be formed by spraying the point exposed from the resist with the chemical etching solution to remove the unnecessary copper foil.

As shown in FIG. 29A, the photoimageable solder resist layers 2328 in which the resin layer 2328a and the resin layer 2328b are laminated are laminated onto the top surfaces of the upper wiring 2324 and the lower wiring 2324. With reference to the laminating conditions, for example, the temperature is set to 110° C., the time is set in the range from 1 to 2 minutes, and the pressure is set to about 2 atmospheres. Then, the resin layer 2328a is partially cured by the after-baking process.

The thickness of the resin layer 2328b is set to e.g. about 35 μm, and the thickness of the resin layer 2328a is e.g. about 25 μm. The cardo type polymer contained resin film later-described is used as the resin layer 2328a. It is preferable that the resins such as polyimide and epoxy having the photosensitivity are used as the resin material constituting the resin layer 2328b, and it is more preferable to use the thermosetting and photosensitive resins such as epoxy which is equal to the resin material constituting the resin layer 2328a.

Then, as shown in FIG. 29B, after the patterning is performed on the photoimageable solder resist layer 2328 by the exposure with the glass as the mask, the opening 2326 having the diameter of e.g. about 100 nm is formed so that the via portion 2323 formed inside the via hole 2322 is exposed. In Example 3, for example, the chemical etching process using chemicals is used for forming the opening 2326. Then, the gold plating is performed on the exposed via portion 2323 (not shown).

The effect that the cardo type polymer contained resin film is used for the resin layer 2328a constituting the photoimageable solder resist layer 2328 in Example 3 will be described below.

The cardo type polymer is a general term for the polymer having the structure in which a cyclic group is directly bonded to the polymer main chain as shown in Chemical Formula V. Where R₁ and R₂ express the bivalent groups such as the alkylene group and the group containing the aromatic ring.
[Chemical Formula V]

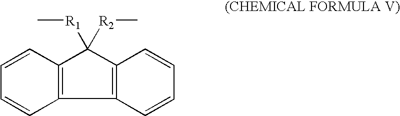

Namely, the cardo type polymer shall mean the polymer having the structure in which the bulky substituent group containing the quaternary carbon atom is substantially perpendicular to the main chain.

It is possible that cyclic portion includes either the saturated bond or the unsaturated bond. In addition to the carbon atom, it is possible that cyclic portion includes atoms such as the nitrogen atom, the oxygen atom, the sulfur atom, and the phosphorus atom. It is possible that the cyclic portion is formed in the polycycle or the fused ring. It is possible that the cyclic portion is bonded to other carbon chains and further cross-linked.

As shown in Chemical Formula V, the cyclic group such as the fluorenyl group which includes the fused ring having the structure, in which the six-membered rings are bonded to both sides of the five-membered ring and the remaining one carbon atom of the five-membered ring is bonded to the main chain, can be cited as an example of the bulky substituent group.

As shown in Chemical Formula VI, the fluorenyl group is one in which the 9-position carbon atom of fluolene is dehydrogenized. In the cardo type polymer, as shown in Chemical Formula V, the fluorenyl group is bonded to the carbon atom of the alkyl group which is of the main chain at the position of the dehydrogenized carbon atom.
[Chemical Formula VI]

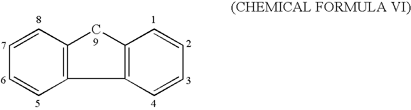

Since the cardo type polymer is one which has the above structure, the cardo type polymer has the following effects:
(1) Rotation constraint of polymer main chain.
(2) Conformation control of main chain and side chain.
(3) Packing obstruction between molecules.
(4) Increase in aromaticity by introducing aromatic substituent group to side chain.

Accordingly, the cardo type polymer has the advantages such as the high mechanical strength, high heat-resistant properties, solvent solubility, high transparency, high refractive index, low birefringence, and higher gas permeability.

The cardo type polymer contained resin film is excellent in the moisture resistance properties and the adhesion properties. Because the resins in the same line are used for the resin layer 2328a constituting the surface layer of the photoimageable solder resist layer 2328 and the resin layer 2328b, the interlayer adhesion properties is stabilized between the resin layer 2328a and the resin layer 2328b. Therefore, the adhesion properties between the resin layer 2328a and the device mounted on the surface of the device mounting board 2400 or other layers can be improved by using the cardo type polymer contained resin film for the resin layer 2328a. Accordingly, the reliability can be improved in the device mounting board 2400.

In the photoimageable solder resist layer 2328 including the resin layer 2328a and the resin layer 2328b, the total thickness of about 60 μm becomes 1.7 times when compared with the thickness of about 35 μm in the conventional photoimageable solder resist layer. Therefore, the total thickness of the device mounting board 2400 becomes thickened when compared with the total thickness of the device mounting board in which the conventional photoimageable solder resist layer is used. At this point, in the device mounting board 2400 of Example 3, since the cardo type polymer contained resin film which is excellent in the resolution and the rigidity is used as the resin layer 2328a, the photoimageable solder resist layer 2328 can be thickened without decreasing the resolution, which result in the photoimageable solder resist layer 2328 having the high rigidity. Accordingly, the amount of warp can be suppressed in the device mounting board 2400. As a result, the reliability can be improved in the device mounting board 2400.

The cardo type polymer contained resin film has the excellent resolution as described later. In the cardo type polymer contained resin film used for the resin layer 2328a in Example 3, the thickness becomes about two-thirds when compared with the conventional resin layer, so that the resin layer 2328a for which the cardo type polymer contained resin film is used has the more excellent resolution. Accordingly, the dimensional accuracy can be improved in making the via hole 2326. As a result, the reliability can be improved in the device mounting board 2400.

The cardo type polymer contained resin film has the high mechanical strength and the excellent heat-resistant properties as described later, so that the reliability can be improved in the device mounting board 2400.

The linear expansion coefficients of the resin layer 2328a and the resin layer 2328b are cause to be relatively close to each other by using the resins in the same line for the resin layer 2328a and the resin layer 2328b. Therefore, the interlayer adhesion properties can be improved between the resin layer 2328a and the resin layer 2328b. As a result, the reliability can be improved in the device mounting board 2400.

It is also possible that the cardo type polymer is one which is formed by the cross-linked polymer having the carboxyl group and the acrylate group in the same molecular chain. Conventionally, the blend of the carboxyl group oligomer having development properties and the multifunctional acryl is used as the general photosensitive varnish. However, the general photosensitive varnish still has room for improvement in the resolution. When the cardo type polymer formed of the cross-linked polymer having the carboxyl group and the acrylate group in the same molecular chain is used instead of the general photosensitive varnish, the cardo type polymer has the carboxyl group having the development properties and the acrylate group which is of the cross-linking group in the same molecular chain, and the cardo type polymer also has the bulky substituent group in the main chain, so that the radical diffusion is difficult to occur. Therefore, in the cardo type polymer contained photoimageable solder resist film, there is the advantage that the resolution is improved.

It is desirable that the cardo type polymer contained resin film satisfies the following physical properties. The following physical properties are the value for the resin portion which does not include the filler and the like, and the physical properties can be appropriately adjusted by adding the filler and the like.

In the cardo type polymer contained resin film, it is preferable that the glass transition temperature (Tg) is e.g. not lower than 180° C., and it is more preferable that Tg is not lower than 190° C. When Tg exists in the above range, the heat-resistant properties are improved in the cardo type polymer contained resin film.

In the cardo type polymer contained resin film, it is preferable that Tg is e.g. not more than 220° C., it is more preferable that Tg is not more than 210° C. When Tg exists in the above range, the cardo type polymer contained resin film can stably be produced by the usual manufacturing method. Tg can be measured by the dynamic viscoelasticity measurement (DMA) of a bulk sample for example.

In the range not more than Tg of the cardo type polymer contained resin film, it is preferable that the linear expansion coefficient (CTE) of the cardo type polymer contained resin film is e.g. not more than 80 ppm/° C., and it is more preferable that CTE is not more than 75 ppm/° C. When CTE exists in the above range, the adhesion properties between the cardo type polymer contained resin film and other members are improved.

In the range not more than Tg of the cardo type polymer contained resin film, it is preferable that CTE of the cardo type polymer contained resin film is e.g. not lower than 50 ppm/° C., and it is more preferable that CTE is not lower than 55 ppm/° C. Further, the resin composition having CTE of not more than 20 ppm/° C. can be obtained by mixing the filler in the cardo type polymer contained resin film. When CTE exists in the above range, the cardo type polymer contained resin film can stably be produced by the usual manufacturing method. CTE can be measured according to the thermal expansion measurement by the thermo-mechanical analysis apparatus (TMA).

It is preferable that heat conductivity of the cardo type polymer contained resin film is e.g. not more than 0.50 W/cm²·sec, and it is more preferable that the heat conductivity is not more than 0.35 W/cm²·sec. When the heat conductivity exists in the above range, the heat-resistant properties are improved in the cardo type polymer contained resin film.

It is preferable that the heat conductivity of the cardo type polymer contained resin film is e.g. not lower than 0.10 W/cm²·sec, and it is more preferable that the heat conductivity is not lower than 0.25 W/cm²·sec. When the heat conductivity exists in the above range, the cardo type polymer contained resin film can stably be produced by the usual manufacturing method. For example, the heat conductivity can be measured by the disk heat flow meter method (ASTM E1530).

In the via portion which has the diameter ranging from 10 to 100 μm in the cardo type polymer contained resin film, it is preferable that a via aspect ratio is e.g. not lower than 0.5, and it is more preferable that the via aspect ratio is not lower than 1. When the via aspect ratio exists in the above range, the resolution is improved in the cardo type polymer contained resin film.

In the via portion which has the diameter ranging from 10 to 100 μm in the cardo type polymer contained resin film, it is preferable that the via aspect ratio is e.g. not more than 5, and it is more preferable that the via aspect ratio is not more than 2. When the via aspect ratio exists in the above range, the cardo type polymer contained resin film can stably be produced by the conventional manufacturing method.

In the case where the alternating electric field having the frequency of 1 MHz is applied to the cardo type polymer contained resin film, it is preferable that the dielectric constant of the cardo type polymer contained resin film is e.g. not more than 4, and it is more preferable that the dielectric constant is not more than 3. When the dielectric constant exists in the above range, the dielectric characteristics such as the high-frequency characteristics are improved in the cardo type polymer contained resin film.

In the case where the alternating electric field having the frequency of 1 MHz is applied to the cardo type polymer contained resin film, it is possible that the dielectric constant is e.g. not lower than 0.1, and it is more preferable that the dielectric constant is not lower than 2.7. When the dielectric constant exists in the above range, the cardo type polymer contained resin film can stably be produced by the conventional manufacturing method.

In the case where the alternating electric field having the frequency of 1 MHz is applied to the cardo type polymer contained resin film, it is preferable that the dielectric dissipation factor of the cardo type polymer contained resin film is e.g. not more than 0.04, and it is more preferable that the dielectric dissipation factor is not more than 0.029. When the dielectric dissipation factor exists in the above range, the dielectric characteristics such as the high-frequency characteristics are improved in the cardo type polymer contained resin film.

In the case where the alternating electric field having the frequency of 1 MHz is applied to the cardo type polymer contained resin film, it is preferable that the dielectric dissipation factor of the cardo type polymer contained resin film is e.g. not lower than 0.001, and it is more preferable that the dielectric dissipation factor is not lower than 0.027. When the dielectric dissipation factor exists in the above range, the cardo type polymer contained resin film can stably be produced by the conventional manufacturing method.

In the cardo type polymer contained resin film, it is preferable that the 24-hour water absorption (wt %) is e.g. not more than 3 wt %, and it is more preferable that the 24-hour water absorption (wt %) is not more than 1.5 wt %. When the 24-hour water absorption exists in the above range, moisture resistance is improved in the cardo type polymer contained resin film.

In the cardo type polymer contained resin film, it is preferable that the 24-hour water absorption (wt %) is e.g. not lower than 0.5 wt %, and it is more preferable that the 24-hour water absorption is not lower than 1.3 wt %. When the 24-hour water absorption (wt %) exists in the above range, the cardo type polymer contained resin film can stably be produced by the conventional manufacturing method.

The characteristics such as the mechanical strength, the heat-resistant properties, the adhesion properties to other members, the resolution, the dielectric characteristics, and the moisture resistance are required for the resin layer 2328a for which the cardo type polymer contained resin film is used. The characteristics required for the photoimageable solder resist film 2328 are realized in a well-balanced manner, when the cardo type polymer contained resin film satisfies the above physical properties.

### EXAMPLE 4

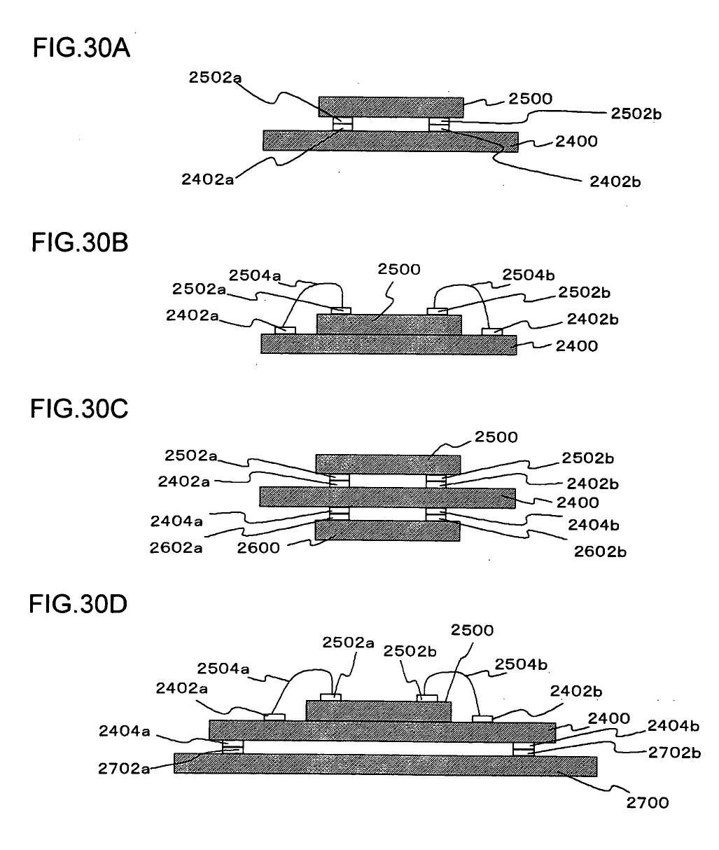

FIGS. 30A to 30D are a sectional view schematically showing various methods of mounting the semiconductor device on the device mounting board 2400 including the four-layer ISB structure according to Example 3.

In Example 4, the cardo type polymer contained resin film is equal to the cardo type polymer contained resin film described in Example 3.

There are various modes in the semiconductor apparatus which is formed by mounting the semiconductor device on the device mounting board 2400 described in Example 3. For example, there is the mode in which the semiconductor device is mounted on the device mounting board 2400 by the flip chip connection or the wire bonding connection. There is the mode the semiconductor device is mounted on the device mounting board 2400 by taking the face up structure or the face down structure. There is the mode in which the semiconductor device is mounted on one side or both sides of the device mounting board 2400. Further, there is the mode in which these various modes are combined.

Specifically, as shown in FIG. 30A, a semiconductor device 2500 such as LSI can be mounted on the device mounting board 2400 of Example 3 in the flip chip form. At this point, electrode pads 2402a and 2402b on the device mounting board 2400 are directly connected to electrode pads 2502a and 2502b of the semiconductor device 2500 respectively.

As shown in FIG. 30B, the semiconductor device 2500 such as LSI can be mounted on the device mounting board 2400 by taking the face up structure. At this point, the electrode pads 2402a and 2402b located on the top of the device mounting board 2400 are connected to the electrode pads 2502a and 2502b located on the top of the semiconductor device 2500 through the gold wires 2504a and 2504b by the wire bonding connection respectively.

As shown in FIG. 30C, the semiconductor device 2500 such as LSI can be mounted on the device mounting board 2400 in the flip chip form, and a semiconductor device 2600 such as IC can be mounted beneath the device mounting board 2400 in the flip chip form. At this point, the electrode pads 2402a and 2402b located on the top of the device mounting board 2400 are directly connected to the electrode pads 2502a and 2502b of the semiconductor device 2500 respectively. Further, the electrode pads 2404a and 2404b located on the lower surface of the device mounting board 2400 are directly connected to electrode pads 2602a and 2602b of the semiconductor device 2600 respectively.

As shown in FIG. 30D, the semiconductor device 2500 such as LSI can be mounted on the device mounting board 2400 by taking the face up structure, and the device mounting board 2400 can be mounted on a printed board 2700. At this point, the electrode pads 2402a and 2402b located on the top of the device mounting board 2400 are connected to the electrode pads 2502a and 2502b located on the top of the semiconductor device 2500 through the gold wires 2504a and 2504b by wire bonding connection respectively. Further, the electrode pads 2404a and 2404b located on the lower surface of the device mounting board 2400 are directly connected to electrode pads 2702a and 2702b located on the top of the printed board 2700 respectively.

As described in Example 3, the cardo type polymer contained resin film is used as the resin layer 2328a in the semiconductor apparatus having any structure described above. As described above, the cardo type polymer contained resin film is excellent in the characteristics such as the moisture resistance, the interlayer adhesion properties, the dielectric characteristics, and the resolution. Therefore, the cardo type polymer contained resin film is excellent in the adhesion properties between the device mounting board 2400 and the device mounted on the device mounting board 2400, the dimensional accuracy can be improved when the via holes are made in the resin layer 2328a, and the parasitic capacitance can be decreased. Further, the film made of the cardo type polymer contained resin film, which has the high mechanical strength, is used for the resin layer 2328a, so that the thick photoimageable solder resist layer 2328 can be formed. Therefore, the warp of the whole of device mounting board 2400 can be suppressed, which improves the accuracy when the device is mounted on the device mounting board 2400. Accordingly, mounting the device on the device mounting board 2400 can provide the semiconductor apparatus having the high reliability.

The invention is not limited to the fourth embodiment, and it is understood that those skilled in the art could modify the fourth embodiment without departing from the scope of the invention.

For example, it is possible that the cardo type polymer contained resin film is used as the resin layer 2328b.

Since the cardo type polymer contained resin film has the features described above, the material which is excellent in the characteristics such as the adhesion properties, the heat-resistant properties, and the dielectric characteristics is used as the resin layer 2328b. Therefore, by using the cardo type polymer contained resin film for the resin layer 2823b, the interlayer adhesion properties can be improved between the resin layer 2328b and the layers adjacent to the resin layer 2328b and the parasitic capacitance between the pieces of wiring can be decreased. Accordingly, the reliability can be improved in the device mounting board 2400 of the Example 4 by using the cardo type polymer contained resin film for the resin layer 2328b. Further, mounting the semiconductor device on the device mounting board 2400 can provide the semiconductor apparatus having the high reliability.

It is possible that the cardo type polymer contained resin film is used as the material constituting the resin layer 2328b in addition to the resin layer 2328a. Therefore, the resin layer 2328a and the resin layer 2328b have the excellent characteristics held by the cardo type polymer contained resin film. As a result, the reliability can further be improved in the device mounting board 2400 of Example 4. Further, mounting the semiconductor device on the device mounting board 2400 can provide the semiconductor apparatus having the high reliability.

It is possible that the cardo type polymer contained resin film is used as the material constituting the base material 2302 or the dielectric resin film 2312 in addition to the resin layer 2328a.

When the cardo type polymer contained resin film is used as the material constituting the base material 2302 in addition to the resin layer 2328a, the following effect can be obtained.

As described above, the cardo type polymer contained resin film is excellent in the adhesion properties and the heat-resistant properties. Accordingly, the reliability can further be improved in the device mounting board 2400 of Example 4 by using the cardo type polymer contained resin film for the base material 2302 in addition to the resin layer 2328a. Further, mounting the semiconductor device on the device mounting board 2400 can provide the semiconductor apparatus having the higher reliability.

When the cardo type polymer contained resin film is used as the material constituting the dielectric resin film 2312, the following effect can be obtained.

As described above, the cardo type polymer contained resin film is excellent in the adhesion properties, the heat-resistant properties, and the dielectric characteristics, so that the interlayer adhesion properties are improved and the parasitic capacitance is decreased between the pieces of wiring in the dielectric resin film 2312. Therefore, the reliability can be more improved in the device mounting board 2400. Accordingly, the reliability can further be improved in the device mounting board 2400 of Example 4 by using the cardo type polymer contained resin film for the dielectric resin film 2312 in addition to the resin layer 2328a. Further, mounting the semiconductor device on the device mounting board 2400 can provide the semiconductor apparatus in which the reliability and the production stability are remarkably improved.

It is also possible that the cardo type polymer contained resin film is used for the base material 2302, the resin layer 2328a, and the resin layer 2328b.

Since the cardo type polymer contained resin film is excellent in the characteristics such as the heat-resistant properties, the mechanical strength, the adhesion properties, the moisture resistance properties, the dielectric characteristics, and the resolution characteristics, the materials constituting the device mounting board 2400 are excellent in the characteristics such as the rigidity, the heat-resistant properties, the interlayer adhesion properties, the parasitic capacitance, the dimensional accuracy in mounting the device, and the flatness. Therefore, the reliability and the production stability can remarkably be improved in the device mounting board 2400 by using the cardo type polymer contained resin film for the base material 2302 and the resin layer 2328b in addition to the resin layer 2328a. Further, mounting the semiconductor device on the device mounting board 2400 can provide the semiconductor apparatus in which the reliability and-the production stability are remarkably improved.

It is also possible that the cardo type polymer contained resin film is used for the dielectric resin film 2312, the resin layer 2328a, and the resin layer 2328b.

Since the cardo type polymer contained resin film is excellent in the characteristics such as the heat-resistant properties, the mechanical strength, the adhesion properties, the moisture resistance properties, the dielectric characteristics, and the resolution characteristics, the materials constituting the device mounting board 2400 are excellent in the characteristics such as the rigidity, the heat-resistant properties, the interlayer adhesion properties, the parasitic capacitance, dimensional accuracy in mounting the device, and the flatness. Therefore, the reliability and the production stability can remarkably be improved in the device mounting board 2400 by using the cardo type polymer contained resin film for the dielectric resin film 2312 and the resin layer 2328b in addition to the resin layer 2328a. Further, mounting the semiconductor device on the device mounting board 2400 can provide the semiconductor apparatus in which the reliability and the production stability are remarkably improved.

It is also possible that the cardo type polymer contained resin film is used for the base material 2302, the dielectric resin film 2312, and the resin layer 2328a.

Since the cardo type polymer contained resin film is excellent in the characteristics such as the heat-resistant properties, the mechanical strength, the adhesion properties, the moisture resistance properties, the dielectric characteristics, and the resolution characteristics, the materials constituting the device mounting board 2400 are excellent in the characteristics such as the rigidity, the heat-resistant properties, the interlayer adhesion properties, the parasitic capacitance, the dimensional accuracy in mounting the device, and the flatness. Therefore, the reliability and the production stability can remarkably be improved in the device mounting board 2400 by using the cardo type polymer contained resin film for the base material 2302 and the dielectric resin layer 2312 in addition to the resin layer 2328a. Further, mounting the semiconductor device on the device mounting board 2400 can provide the semiconductor apparatus in which the reliability and the production stability are remarkably improved.

It is also possible that the cardo type polymer contained resin film is used for the base material 2302, the dielectric resin film 2312, resin layer 2328a, and the resin layer 2328b.

Since the cardo type polymer contained resin film is excellent in the characteristics such as the heat-resistant properties, the mechanical strength, the adhesion properties, the moisture resistance properties, the dielectric characteristics, and the resolution characteristics, the materials constituting the device mounting board 2400 are excellent in the characteristics such as the rigidity, the heat-resistant properties, the interlayer adhesion properties, the parasitic capacitance, the dimensional accuracy in mounting the device, and the flatness. Therefore, the reliability and the production stability can remarkably be improved in the device mounting board 2400 by using the cardo type polymer contained resin film for the base material 2302, the dielectric resin film 2312, and the resin layer 2328b in addition to the resin layer 2328a. Further, mounting the semiconductor device on the device mounting board 2400 can provide the semiconductor apparatus in which the reliability and the production stability are remarkably improved.

It is also possible that the cardo type polymer contained resin film is used for the resin layer constituting the photoimageable solder resist layer of the device mounting board or the like which has the ISB structure including at least four wiring layers, e.g. six wiring layers. It is also possible that the cardo type polymer contained resin film is used for the surface resin layer portion of the photoimageable solder resist layer in the board of other semiconductor packages.

Constitution using the photoimageable solder resist layer 2328 in which the resin layer 2328a and the resin layer 2328b are previously laminated is described in Example 4. However, it is also possible that the resin layer 2328a is formed on the resin layer 2328b after the resin layer 2328b is formed on the dielectric resin film 2312.

In Example 4, the two resin layers of the resin layer 2328a and the resin layer 2328b are laminated, and constitution using the photoimageable solder resist layer 2328 in which the cardo type polymer contained resin film is used for one of the two resin layers is described. However, it is also possible that the photoimageable solder resist layer in which at least three resin layers are laminated is used and the cardo type polymer contained resin film is used for at least one of the three resin layers. Therefore, the cardo type polymer contained resin film is excellent in the characteristics such as the heat-resistant properties, the mechanical strength, the adhesion properties, the moisture resistance properties, the dielectric characteristics, and the resolution characteristics, so that the resin layer for which the cardo type polymer contained resin film constituting the device mounting board 2400 is used is excellent in the characteristics such as the rigidity, the heat-resistant properties, the interlayer adhesion properties, the parasitic capacitance, the dimensional accuracy in mounting the device, and the flatness. Accordingly, the reliability and the production stability can be improved in the device mounting board 2400. Further, mounting the semiconductor device on the device mounting board can provide the semiconductor apparatus in which the reliability and the production stability are improved.

1. A device mounting board on which a device is mounted, the device mounting board comprising:
a base material;
a dielectric film which is provided on the base material; and
a solder resist layer which is provided on the dielectric film,
wherein said solder resist layer contains a cardo type polymer.

2. A device mounting board according to claim 1, wherein wiring which connects said device is provided in said solder resist layer.

3. A device mounting board according to claim 1, wherein a glass transition temperature of said solder resist layer ranges from 180° C. to 220° C., and
a dielectric dissipation factor of said solder resist layer ranges from 0.001 to 0.04 when an alternating electric field having a frequency of 1 MHz is applied to said solder resist layer.

4. A device mounting board according to claim 2, wherein the glass transition temperature of said solder resist layer ranges from 180° C. to 220° C., and
the dielectric dissipation factor of said solder resist layer ranges from 0.001 to 0.04 when the alternating electric field having the frequency of 1 MHz is applied to said solder resist layer.

5. A device mounting board according to claim 3, wherein a linear expansion coefficient of said solder resist layer ranges from 50 ppm/° C. to 80 ppm/° C. in a range not more than the glass transition temperature of said solder resist layer.

6. A device mounting board on which a device is mounted, the device mounting board comprising:
a base material; and
a dielectric film which is provided on the base material,
wherein said base material contains a cardo type polymer.

7. A device mounting board according to claim 6, wherein wiring which connects said device is provided on said dielectric film.

8. A device mounting board according to claim 6, wherein a glass transition temperature of said base material ranges from 180° C. to 220° C., and
a dielectric dissipation factor of said base material ranges from 0.001 to 0.04 when an alternating electric field having a frequency of 1 MHz is applied to said base material.

9. A device mounting board according to claim 7, wherein a glass transition temperature of said base material ranges from 180° C. to 220° C., and
a dielectric dissipation factor of said base material ranges from 0.001 to 0.04 when an alternating electric field having a frequency of 1 MHz is applied to said base material.

10. A device mounting board according to claim 8, wherein the linear expansion coefficient of said base material ranges from 50 ppm/° C. to 80 ppm/° C. in the range not more than the glass transition temperature of said base material.

11. A device mounting board according to claim 9, wherein the linear expansion coefficient of said base material ranges from 50 ppm/° C. to 80 ppm/° C. in the range not more than the glass transition temperature of said base material.

12. A device mounting board on which a device is mounted, the device mounting board comprising:
a base material; and
a dielectric film which is provided on the base material;
wherein said dielectric film contains a cardo type polymer.

13. A device mounting board according to claim 12, wherein wiring which connects said device is provided on said dielectric film.

14. A device mounting board according to claim 12, wherein a glass transition temperature of said dielectric film ranges from 180° C. to 220° C., and
a dielectric dissipation factor of dielectric film ranges from 0.001 to 0.04 when an alternating electric field having a frequency of 1 MHz is applied to said dielectric film.

15. A device mounting board according to claim 13, wherein the glass transition temperature of said dielectric film ranges from 180° C. to 220° C., and
the dielectric dissipation factor of said dielectric film ranges from 0.001 to 0.04 when the alternating electric field having the frequency of 1 MHz is applied to said dielectric film.

16. A device mounting board according to claim 14, wherein a linear expansion coefficient of said dielectric film ranges from 50 ppm/° C. to 80 ppm/° C. in a range not more than the glass transition temperature of said dielectric film.

17. A device mounting board according to claim 7, wherein a second dielectric film is provided on said dielectric film, and
said wiring is covered with said second dielectric film.

18. A device mounting board according to claim 13, wherein the second dielectric film is provided on said dielectric film, and
said wiring is covered with said second dielectric film.

19. A device mounting board according to claim 17, wherein said second dielectric film contains the cardo type polymer.

20. A device mounting board according to claim 18, wherein said second dielectric film contains the cardo type polymer.

21. A device mounting board according to claim 19, wherein the glass transition temperature of said second dielectric film ranges from 180° C. to 220° C., and
the dielectric dissipation factor of said second dielectric film ranges from 0.001 to 0.04 when the alternating electric field having the frequency of 1 MHz is applied to said second dielectric film.

22. A device mounting board according to claim 20, wherein the glass transition temperature of said second dielectric film ranges from 180° C. to 220° C., and
the dielectric dissipation factor of said second dielectric film ranges from 0.001 to 0.04 when the alternating electric field having the frequency of 1 MHz is applied to said second dielectric film.

23. A device mounting board according to claim 21, wherein the linear expansion coefficient of said second dielectric film ranges from 50 ppm/° C. to 80 ppm/° C. in the range not more than the glass transition temperature of said second dielectric film.

24. A device mounting board according to claim 22, wherein the linear expansion coefficient of said second dielectric film ranges from 50 ppm/° C. to 80 ppm/° C. in the range not more than the glass transition temperature of said second dielectric film.

25. A device mounting board on which a device is mounted, the device mounting board comprising:
a base material;
a dielectric film which is provided on the base material; and
a solder resist layer which is provided on the dielectric film, the solder resist layer including a plurality of layers,
wherein at least one of layers in said solder resist layer contains a cardo type polymer.

26. A device mounting board according to claim 25, wherein a top surface layer of said solder resist layer contains the cardo type polymer.

27. A device mounting board according to claim 25, wherein wiring which connects said device is provided in said solder resist layer.

28. A device mounting board according to claim 26, wherein the wiring which connects said device is provided in said solder resist layer.

29. A device mounting board according to claim 25, wherein a glass transition temperature of the solder resist layer containing said cardo type polymer ranges from 180° C. to 220° C., and
a dielectric dissipation factor of the solder resist layer containing said cardo type polymer ranges from 0.001 to 0.04 when an alternating electric field having a frequency of 1 MHz is applied to the solder resist layer containing said cardo type polymer.

30. A device mounting board according to claim 26, wherein the glass transition temperature of the solder resist layer containing said cardo type polymer ranges from 180° C. to 220° C., and
the dielectric dissipation factor of the solder resist layer containing said cardo type polymer ranges from 0.001 to 0.04 when the alternating electric field having the frequency of 1 MHz is applied to the solder resist layer containing said cardo type polymer.

31. A device mounting board according to claim 27, wherein the glass transition temperature of the solder resist layer containing said cardo type polymer ranges from 180° C. to 220° C., and
the dielectric dissipation factor of the solder resist layer containing said cardo type polymer ranges from 0.001 to 0.04 when the alternating electric field having the frequency of 1 MHz is applied to the solder resist layer containing said cardo type polymer.

32. A device mounting board according to claim 29, wherein a linear expansion coefficient of the solder resist layer containing said cardo type polymer ranges from 50 ppm/° C. to 80 ppm/° C. in a range not more than the glass transition temperature of the solder resist layer containing said cardo type polymer.
